(19) United States
(12) Patent Application Publication
(10) Pub. No.: US 2025/0106633 A1
(43) Pub. Date: Mar. 27, 2025

(54) METHOD, COMMUNICATION DEVICE, AND STORAGE MEDIUM FOR TRANSMITTING INFORMATION

(71) Applicant: Beijing Xiaomi Mobile Software Co., Ltd., Beijing (CN)

(72) Inventors: Haoran LIANG, Beijing (CN); Wei LU, Beijing (CN)

(73) Assignee: Beijing Xiaomi Mobile Software Co., Ltd., Beijing (CN)

(21) Appl. No.: 18/832,133

(22) PCT Filed: Jan. 29, 2022
(86) PCT No.: PCT/CN2022/075118

§ 371 Date: Jul. 23, 2024

(51) Int. Cl. H04W 12/104; H04W 12/043

(52) U.S. Cl. CPC H04W 12/104; H04W 12/043

(57) ABSTRACT

The present disclosure relates to a method, apparatus, communication device, and storage medium for transmitting information. A first user equipment (UE) determines, according to long-term key information sent by a core network, an integrity protection key and a confidentiality protection key of a distance measurement announcement message, wherein the integrity protection key and the confidentiality protection key are respectively used for replacing, when the first UE cannot obtain a discovery key from a mobile communication network, the discovery key to perform integrity protection of the distance measurement announcement message and to perform confidentiality protection of predetermined confidential information in the distance measurement announcement message.

### CROSS-REFERENCE TO RELATED APPLICATION

The present application is a U.S. National Phase of International Patent Application Serial No. PCT/CN2022/075118 filed on Jan. 29, 2022. The entire contents of the above-cited application are hereby incorporated by reference in their entirety for all purposes.

### BACKGROUND OF THE INVENTION

In a cellular mobile communication system, a ranging service may be to determine a distance between two User Equipments (UEs) and/or a direction of one UE and the other UE through direct communication connection.

As shown in FIG. 1, an observer UE 1, i.e., a ranging client or a ranging requester requesting ranging, has a reference plane and a reference direction. The direction from a target UE 2 to the observer UE is an included angle between the line connecting the observer UE with the target UE and the reference direction, and is represented by an azimuth direction and an elevation direction. An azimuth angle of the target UE is the angle formed by the reference direction and the projection of a straight line from the observer UE to the target UE on the same plane as the reference direction orthogonal to the zenith. The elevation direction of the target UE is the angle above the horizontal plane.

### SUMMARY OF THE INVENTION

In view of the above, the disclosure provides a method, communication device, and storage medium for transmitting information.

An example in a first aspect of the disclosure provides a method for transmitting information, performed by a first user equipment (UE), and including:
determining a ranging integrity key and a ranging encryption key of a ranging announcement message according to long-term key information sent by a core network, where the ranging integrity key and the ranging encryption key are used to carry out, in response to determining that the first UE is unable to acquire a discovery key from a mobile communication network, integrity protection of the ranging announcement message and encryption protection of predetermined encrypted information in the ranging announcement message in place of the discovery key, respectively.

An example in a second aspect of the disclosure provides a method for transmitting information, performed by a core network, including:
sending long-term key information to a first UE;
where the long-term key information is used for determining a ranging integrity key and a ranging encryption key of a ranging announcement message by the first UE, where the ranging integrity key and the ranging encryption key are used to carry out, in response to determining that the first UE is unable to acquire a discovery key from a mobile communication network, integrity protection of the ranging announcement message and encryption protection of predetermined encrypted information in the ranging announcement message in place of the discovery key, respectively.

An example in a third aspect of the disclosure provides a method for transmitting information, performed by a second user equipment (UE), and including:
receiving a ranging announcement message sent by a first UE on a direct link, where the ranging announcement message comprises a long-term key identifier of a long-term key, where the long-term key identifier is used for determining a ranging integrity key and a ranging encryption key of the ranging announcement message by the second UE, where the ranging integrity key and the ranging encryption key are used to carry out, in response to determining that the first UE is unable to acquire a discovery key from a mobile communication network, integrity protection of the ranging announcement message and encryption protection of predetermined encrypted information in the ranging announcement message in place of the discovery key, respectively.

An example in a fourth aspect of the disclosure provides a communication device for transmitting information, and including a processor, a memory, and an executable program stored in the memory and runnable by the processor, where the executable program, when executed by the processor, causes the processor to execute the steps of the method for transmitting information as described in the first aspect or the second or the third aspect.

An example in a fifth aspect of the disclosure provides a storage medium for transmitting information, storing an executable program which, when executed by a processor, causes the processor to implement the steps of the method for transmitting information as described in the first aspect or the second or the third aspect.

It is to be understood that the above general description and the following detailed description are merely illustrative and explanatory, and do not limit the embodiments of the present disclosure.

### BRIEF DESCRIPTION OF DRAWINGS

The accompanying drawings herein are incorporated in and form part of the specification, and illustrate principles in accordance with the embodiments of the present disclosure and used together with the specification to explain the embodiments of the present disclosure.

FIG. 1 is a schematic diagram of a UE ranging according to an illustrative example;

FIG. 2 is a schematic diagram of a structure of a wireless communication system according to an illustrative example;

FIG. 3a is a schematic diagram of another UE ranging according to an illustrative example;

FIG. 3b is yet schematic diagram of yet another UE ranging according to an illustrative example;

FIG. 3c is a schematic diagram of still another UE ranging according to an illustrative example;

FIG. 4 is a flow diagram of a method for transmitting information according to an illustrative example;

FIG. 5 is a flow diagram of another method for transmitting information according to an illustrative example;

FIG. 6 is a flow diagram of yet another method for transmitting information according to an illustrative example;

FIG. 7 is a flow diagram of still another method for transmitting information according to an illustrative example;

FIG. 8 is a flow diagram of still another method for transmitting information according to an illustrative example;

FIG. 9 is a flow diagram of still another method for transmitting information according to an illustrative example;

FIG. 10 is a flow diagram of still another method for transmitting information according to an illustrative example;

FIG. 11 is a block diagram of an apparatus for transmitting information according to an illustrative example;

FIG. 12 is a block diagram of another apparatus for transmitting information according to an illustrative example;

FIG. 13 is a block diagram of yet another apparatus for transmitting information according to an illustrative example; and

FIG. 14 is a block diagram of a communication device for transmitting information according to an illustrative example.

### DETAILED DESCRIPTION OF THE INVENTION

Illustrative examples will be described in detail here, examples of which are shown in the accompanying drawings. When the following description relates to accompanying drawings, same numbers in different accompanying drawings denote the same or similar elements unless otherwise indicated. The implementations described in the following illustrative examples do not represent all implementations consistent with the embodiments of the present disclosure, and rather, are merely examples of the apparatuses and methods consistent with some aspects of the embodiments of the present disclosure as attached.

The terms used in the embodiments of the present disclosure are for the purpose of describing specific embodiments merely and are not intended to limit the embodiments of the present disclosure. The singular forms “a”, “said” and “the” used in the embodiments of the present disclosure are also intended to include the plural forms, unless the context clearly indicates other meaning. It is also to be understood that the term “and/or” as used herein refers to and includes any or all possible combinations of one or more associated listed items.

It is to be understood that although the terms “first”, “second”, “third”, etc., may be used to describe various information in the embodiments of the present disclosure, this information is not limited to these terms. These terms are merely used to distinguish the same type of information from each other. For example, without departing from the scope of the embodiments of the present disclosure, first information may also be referred to as second information, and similarly, second information may also be referred to as first information. Depending on the context, the word “if” as used herein may be interpreted as “when” or “as” or “in response to determining”.

The present disclosure relates to but is not limited to the technical field of wireless communication, and in particular, to a method, apparatus, communication device, and storage medium for transmitting information.

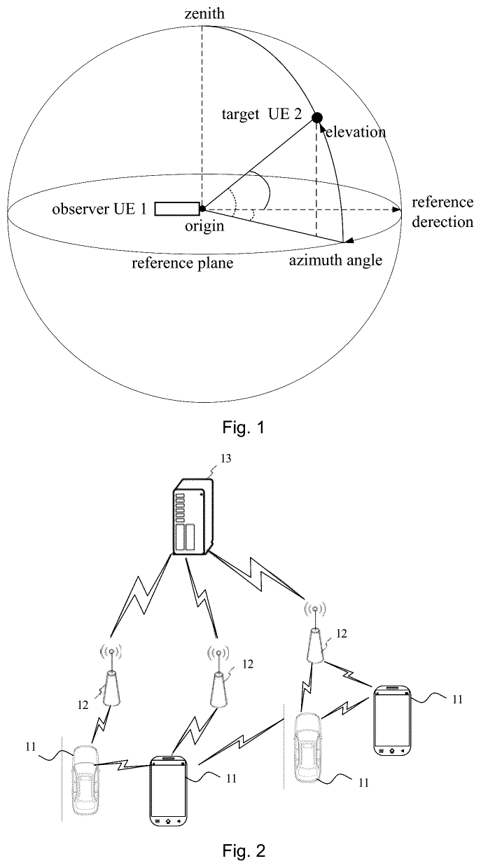

Reference is made to FIG. 2, which shows a schematic diagram of a structure of a wireless communication system provided by an embodiment of the present disclosure. As shown in FIG. 2, the wireless communication system is a communication system based on a cellular mobile communication technology, and the wireless communication system may include several terminals 11 and several base stations 12.

A terminal 11 may be a device that provides voice and/or data connectivity to a user. The terminal 11 may communicate with one or more core networks via a Radio Access Network (RAN). The terminal 11 may be an Internet of Things (IoT) terminal, such as a sensor device, a mobile phone (or referred to as a “cellular” phone) and a computer with an IoT terminal, such as a fixed, portable, pocket-sized, handheld, computer-built-in, or vehicle-mounted device, for example, a Station (STA), a subscriber unit, a subscriber station, a mobile station, a mobile, a remote station, an access point, a remote terminal, an access terminal, a user terminal, a user agent, a user device, or a UE. Alternatively, the terminal 11 may also be a device of an unmanned aerial vehicle. Alternatively, the terminal 11 may also be a vehicle-mounted device, such as a driving computer with a wireless communication function, or a wireless communication device externally connected to the driving computer. Alternatively, the terminal 11 may be a roadside device, such as a street lamp, a signal lamp, or other roadside devices with a wireless communication function.

A base station 12 may be a network-side device in a wireless communication system. The wireless communication system may be a 4th generation mobile communication (4G) system, also referred to as a Long-Term Evolution (LTE) system; alternatively, the wireless communication system may also be a 5G system, also referred to as a New Radio (NR) system or a 5G NR system. Alternatively, the wireless communication system may be a next generation system of the 5G system. The access network in the 5G system may be referred to as New Generation-Radio Access Network (NG-RAN). Alternatively, the wireless communication system may be the MTC system.

A base station 12 may be an evolved base station (eNB) used in the 4G system. Alternatively, the base station 12 may be a base station (gNB) using a centralized distributed architecture in the 5G system. When using a centralized distributed architecture, the base station 12 typically includes a central unit (CU) and at least two distributed units (DUs). The central unit is provided with a protocol stack of a Packet Data Convergence Protocol (PDCP) layer, a Radio Link Control (RLC) layer, and a Media Access Control (MAC) layer; the distribution units are provided with a protocol stack of a Physical (PHY) layer. The embodiments of the present disclosure do not limit the specific implementation of the base station 12.

A wireless connection may be established between a base station 12 and a terminal 11 through a wireless air interface. In different embodiments, the wireless air interface is a wireless air interface based on a 4th generation mobile communication network technology (4G) standard; alternatively, the wireless air interface is a wireless air interface based on a 5th generation mobile communication network technology (5G) standard, for example, the wireless air interface is a new radio; alternatively, the wireless air interface may also be a wireless air interface based on the next generation of mobile communication network technology standard based on 5G.

In some embodiments, an End to End (E2E) connection may also be established between the terminals 11, for example, scenarios such as vehicle to vehicle (V2V) communication, vehicle to infrastructure (V2I) communication and vehicle to pedestrian (V2P) communication in vehicle to everything (V2X).

In some embodiments, the wireless communication system described above may also include a network management device 13.

The several base stations 12 are connected to the network management device 13, respectively. The network management device 13 may be a core network device in a wireless communication system. For example, the network management device 13 may be a Mobility Management Entity (MME) in an Evolved Packet Core (EPC). Alternatively, the network management device may also be other core network devices, such as a Serving GateWay (SGW), a Public Data Network GateWay (PGW), a Policy and Charging Rules Function (PCRF), or a Home Subscriber Server (HSS). The embodiments of the present disclosure do not limit the implementation form of the network management device 13.

The execution entity involved in the embodiments of the present disclosure includes but is not limited to: a UE such as a mobile phone terminal in a cellular mobile communication system, and a network-side device, such as an access network device, for example, a base station and a core network.

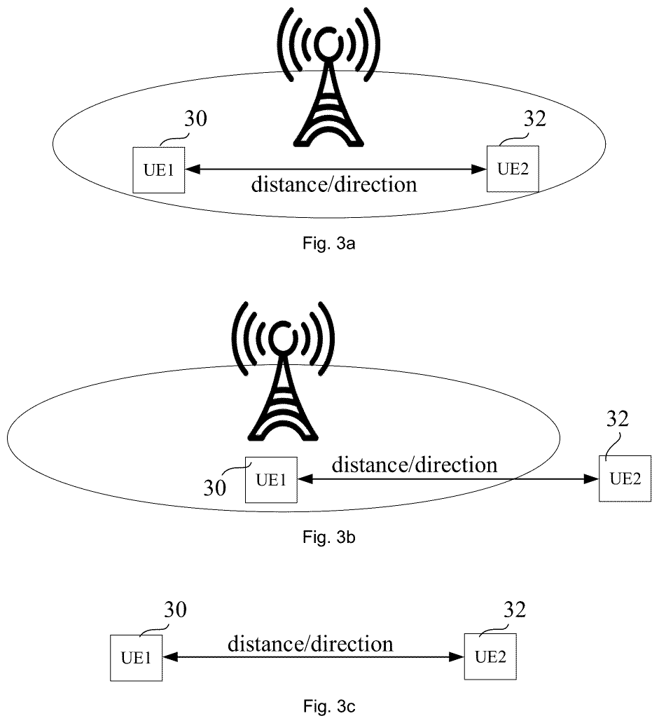

In the 5G cellular mobile communication system, a ranging service may be performed regardless of whether there is coverage of 5G signals. As shown in FIG. 3a, two UEs 30, 32 are under the coverage of 5G signals for ranging; as shown in FIG. 3b, one of the two UEs 30, 32 is under the coverage of 5G signals for ranging; as shown in FIG. 3c, both of the two UEs 30, 32 are outside the coverage of 5G signals for ranging.

Before ranging the target UE 2, the observer UE 1 needs to detect and identify the nearby target UE by using the ranging-restricted ranging announcement message. For the model A restricted ranging discovery process, an announcement UE (observer UE or target UE) notifies the peer UE of specific information that may be used, and the peer UE monitors nearby specific information of interest, which has the authority to discover the announcement UE. In the model A restricted ranging discovery process without a privacy protection mechanism, the ranging announcement message will reveal the privacy of the UE participating in the ranging process. Where both the observer UE 1 and the target UE 2 are within the coverage of a mobile communication network such as 5G (as shown in FIG. 3a), the network function of the mobile communication network can help protect the ranging announcement message by providing a discovery key to the ranging participants (the observer UE 1 and the target UE 2). The discovery key is time-effective. After the discovery key expires, the discovery key will be invalidated. The network function can provide a discovery key again to align for updates. However, in some scenarios with mobile communication network coverage (as shown in FIG. 3b), when the UE with ranging enabled (the second UE 32 as shown in FIG. 3b) has an expired ranging discovery key, but is not covered by the mobile communication network, the integrity and security of the ranging announcement message cannot be protected because the discovery key cannot be updated.

Thus, when the UE is out of the coverage of the mobile communication network and cannot update the discovery key, how to ensure the integrity and security of the ranging announcement message is an urgent problem to be solved.

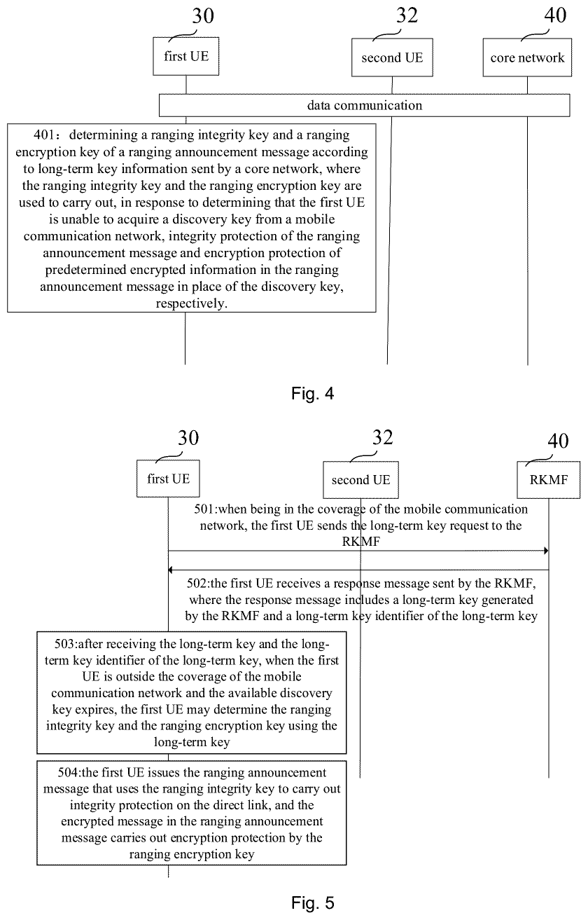

As shown in FIG. 4, the present illustrative example provides a method for transmitting information, performed by a first UE 30 of a cellular mobile communication system, including:

Step 401: determining a ranging integrity key and a ranging encryption key of a ranging announcement message according to long-term key information sent by a core network 40, where the ranging integrity key and the ranging encryption key are used to carry out, in response to determining that the first UE 30 is unable to acquire a discovery key from a mobile communication network, integrity protection of the ranging announcement message and encryption protection of predetermined encrypted information in the ranging announcement message in place of the discovery key, respectively.

Here, management behaviors such as generation and distribution of Long-Term Keys (LTKs) may be carried out by a network element with a Ranging Key Management Function (RKMF) in a core network 40 such as a mobile communication network, such as a 5G cellular mobile communication network. The RKMF may send long-term key information to the UE upon request of the UE ranging. The long-term key information is unique to each UE requesting the long-term key.

The first UE 30 and the second UE 32 may be an observer UE or a target UE carrying out ranging, respectively. For example, the ranging announcement message may be sent by the target UE 2 for the observer UE 1 to discover messages from the target UE 2. the observer UE 1 can monitor the ranging announcement message and respond to the ranging announcement message that meets a response condition, thus completing the discovery of the target UE 2 by the observer UE 1. The first UE 30 may be a sending object of the ranging announcement message, and the second UE 32 may be a receiving object of the ranging announcement message. For example, the first UE 30 may be a target UE carrying out ranging, and the second UE 32 may be an observer UE carrying out ranging; alternatively, the first UE 30 may be an observer UE carrying out ranging, and the second UE 32 may be a target UE carrying out ranging.

The integrity protection of the ranging announcement message may be achieved in many ways such as generating unique ranging integrity information for the ranging announcement message by using a ranging integrity algorithm. The ranging integrity information may be computed using hash functions, etc. In the process of generating the ranging integrity information, the ranging integrity key may be added to provide security protection for the ranging integrity information. For example, before using the ranging integrity algorithm, the ranging integrity key may be added to the ranging announcement message to generate encrypted ranging integrity information, or after generating the ranging integrity information by using the ranging integrity algorithm, the ranging integrity key may be used for encrypting the ranging integrity information.

The encryption protection of the ranging announcement message may be achieved by including predetermined encrypted information in the ranging announcement message, the predetermined encrypted information that needs to be encrypted using a ranging encryption key. The disclosure scope of the predetermined encrypted information is limited, and merely the UE with permission can read the predetermined encrypted information. The information content included in the predetermined encrypted information may be set in advance by a user, etc. The predetermined encrypted information may include ranging requirements such as ranging precision and ranging time.

Here, the ranging integrity key and the ranging encryption key may be determined according to the discovery key or may be determined according to the long-term key information. The discovery key may be a key used by the first UE 30 to send the ranging announcement message when the first UE 30 is connected to the mobile communication network. The discovery key may be directly used as a ranging integrity key and a ranging encryption key. However, the discovery key is time-effective. When the discovery key is invalid or unable to be updated in time, an updated discovery key may be determined according to the long-term key information, that is, the ranging integrity key and the ranging encryption key may be used as an alternative to the updated discovery key.

The long-term key information may be a ranging integrity key for determining to carry out integrity protection of the ranging announcement message when the first UE 30 is unable to use the discovery key, and may be a ranging encryption key for determining to carry out encryption protection of the predetermined encrypted information.

According to the method, communication device, and storage medium for transmitting information of the present disclosure, a first UE 30 determines a ranging integrity key and a ranging encryption key of a ranging announcement message according to long-term key information sent by a core network 40. The ranging integrity key and the ranging encryption key are used to carry out, in response to determining that the first UE 30 is unable to acquire a discovery key from a mobile communication network, integrity protection of the ranging announcement message and encryption protection of predetermined encrypted information in the ranging announcement message in place of the discovery key, respectively. In this way, according to the long-term key information sent by the core network 40, the first UE 30 can use the long-term key information to determine the Ranging Integrity Key (RIK) and the Ranging Encryption Key (REK) when the discovery key cannot be used to carry out integrity protection of the ranging announcement message and when the discovery key cannot be used to carry out encryption protection of the encrypted information, so as to achieve the integrity protection of the ranging announcement message and the encryption protection of the encrypted information. In this way, may be found in time when a data transmission error or tampering occurs in the ranging announcement message in transmission process, thus improving the reliability of transmitting the ranging announcement message and improving the security of encrypted information.

In one embodiment, the long-term key information includes at least the long-term key. Determining a ranging integrity key and a ranging encryption key of a ranging announcement message according to long-term key information sent by a core network 40 may include determining the ranging integrity key and the ranging encryption key of the ranging announcement message according to the long-term key.

For example, the first UE 30 may determine the ranging integrity key and the ranging encryption key based on a long-term key and a random number using a preset algorithm.

When the first UE 30 remains connected to the mobile communication network, the discovery key provided by the core network 40 may be used for carrying out encryption protection and integrity protection.

When the first UE 30 is unable to acquire the discovery key from the mobile communication network, or fails to acquire the discovery key, the long-term key may be used to determine the ranging integrity key and the ranging encryption key as an alternative to the discovery key. The first UE 30 can calculate the long-term key using a preset algorithm, so as to determine the ranging integrity key and the ranging encryption key. For example, a ranging integrity key and a ranging encryption key are determined through a logical operation, etc., between a long-term key and a random number.

The first UE 30 being unable to acquire a discovery key from a mobile communication network may include: the first UE 30 being outside the coverage of the mobile communication network, so that the discovery key cannot be obtained, etc.

The first UE 30 failing to acquire the discovery key may include: the core network 40 being unable to respond to the request of the first UE 30 to acquire the discovery key due to the load, etc.

In one embodiment, the first UE 30 being unable to acquire a discovery key from a mobile communication network includes:
the first UE 30 being disconnected from the mobile communication network when the discovery key obtained from the mobile communication network is invalidated.

Under the coverage of the mobile communication network, the discovery key sent by the core network 40 to the first UE 30 is time-effective. After the discovery key expires, the discovery key will be invalidated. When the first UE 30 is disconnected from the mobile communication network and the discovery key is found to be invalidated, the first UE 30 cannot use the discovery key. The first UE 30 can use the long-term key to determine the ranging integrity key and the ranging encryption key, thus achieving the integrity protection of the ranging announcement message and the encryption protection of the predetermined encrypted information.

The first UE 30 may receive the long-term key information sent by the core network 40 within the mobile communication network. The long-term key information may be used for determining the long-term key by the first UE 30.

For example, the long-term key information may be an algorithm, a parameter, etc., for calculating the long-term key. The first UE 30 may acquire the long-term key information from the core network 40 while maintaining connected to the mobile communication network.

In one embodiment, the long-term key information includes the long-term key and/or a long-term key identifier of the long-term key.

The core network 40 can merely send the long-term key to the first UE 30, and the first UE 30 can query the long-term key identifier corresponding to the long-term key from a pre-stored key list. The core network 40 can also merely send the long-term key identifier to the first UE 30, and the first UE 30 can query the long-term key corresponding to the long-term key from the pre-stored key list. The key list may be sent by the core network 40 to the first UE 30 in advance, may be pre-agreed upon by the protocol, or may be obtained by the first UE 30 in other manners, which will not be limited in the present disclosure. The key list may include a corresponding relationship between the long-term key identifier and the long-term key. Here, the long-term key identifier may be used to uniquely identify the long-term key.

Optionally, the core network 40 may also send the long-term key and the long-term key identifier of the long-term key to the first UE 30.

After the core network 40 sends the long-term key information to the first UE 30, the long-term key information may be stored.

When the first UE 30 sends the ranging announcement message, the long-term key identifier may be included in the ranging announcement message for the core network 40, such as the RKMF, to determine the long-term key used by the ranging integrity key and the ranging encryption key of the ranging announcement message.

In one embodiment, the core network 40 sends the long-term key information to the first UE 30 through the mobile communication network in response to the core network 40 determining that the first UE 30 has a ranging layer identifier corresponding to the first UE 30 at a ranging layer.

The first UE 30 may send a long-term key request to the core network 40 to request the core network 40 to send information related to the long-term key, such as long-term key information, where the long-term key request may carry a ranging layer identifier corresponding to the first UE 30. The ranging layer identifier may be configured for the first UE 30 when the first UE 30 carries out ranging layer authentication. The ranging layer identifier may be configured for the first UE 30 by a core network 40, etc. The ranging layer identifier may be used to characterize that the first UE 30 has the authority to send a ranging announcement message. When the first UE 30 has a ranging layer identifier, it is indicated that the first UE 30 has the authority to send a ranging announcement message, and the core network 40 can send the long-term key information to the first UE 30 for the first UE 30 to carry out the integrity protection of the ranging announcement message and the encryption protection of the encrypted message.

For example, as shown in FIG. 5, the step of the first UE 30 obtaining the long-term key information from the core network 40, and carrying out integrity protection of the ranging announcement message and carrying out encryption protection of the encrypted message by using the long-term key includes the following steps.

Step 501: when being in the coverage of the mobile communication network, the first UE 30 sends the long-term key request to the RKMF.

Step 502: when being in the coverage of the mobile communication network, the first UE 30 receives a response message sent by the RKMF, where the response message includes a long-term key and a long-term key identifier of the long-term key is generated by the RKMF. The long-term key identifier is used to uniquely identify the long-term key.

Step 503: after receiving the long-term key and the long-term key identifier of the long-term key, when the first UE 30 is outside the coverage of the mobile communication network and the available discovery key expires, the first UE 30 may determine the ranging integrity key and the ranging encryption key by using the long-term key.

In this way, through the long-term key information sent by the core network 40, the first UE 30 can determine the ranging integrity key and the ranging encryption key by using the long-term key information when the discovery key cannot be used to carry out integrity protection of the ranging announcement message and when the discovery key cannot be used to carry out encryption protection of the encrypted information, so as to achieve the integrity protection of the ranging announcement message and the encryption protection of the encrypted information. In this way, when a data transmission error or tampering occurs in the ranging announcement message in the transmission process, the data transmission error or tampering may be found in time, thus improving the reliability of transmitting the ranging announcement message and improving the security of encrypted information.

It is to be understood that the above Step 503 may be implemented alone, may be implemented in combination with Step 501 and Step 502, and the implementation sequence may be adjusted as needed, which is not limited by the present disclosure.

In one embodiment, the determining a ranging integrity key and the ranging encryption key of the ranging announcement message according to long-term key information sent by the core network 40 includes:
determining an intermediate key according to the long-term key and a random number; and
determining the ranging integrity key and the ranging encryption key according to the intermediate key.

Here, algorithms for calculating the ranging integrity key and the ranging encryption key by the first UE 30 may be the same or different. The ranging integrity key and the ranging encryption key may be generated respectively by the same algorithm but with different algorithm parameters, such as random numbers.

The first UE 30 determines the ranging integrity key and the ranging encryption key based on a long-term key and a random number using a preset algorithm. The first UE 30 may also first determine an intermediate key using a preset algorithm, and then determine the ranging integrity key and the ranging encryption key according to the intermediate key.

The first UE 30 may determine an intermediate key based on a long-term key and a random number by using a first sub-algorithm, the first sub-algorithm may be indicated by the core network 40, specified by the communication protocol, or agreed upon between the first UE 30 and the core network 40.

Here, there may be one or more random numbers for determining the intermediate key. The long-term key and the intermediate key may have a plurality of bits. For example, the long-term key and the intermediate key may both have 256 bits.

For example, the intermediate key KD may be determined based on the long-term key and a random number, using, but not limited to, the following input parameters:
FC=0x58
P0=random number_1 (such as a ranging layer identifier)
L0=length of the random number_1 (such as 0x00 0x03)
P1=random number_2 (such as a ranging service code)
L1=length of the random number_2 (such as 0x00 0x10)
P2=random number_3 (optional)
L2=length of the random number_3 (such as 0x00 0x10)

In one embodiment, determining the ranging integrity key and the ranging encryption key according to the intermediate key includes: determining, using a second sub-algorithm, the ranging integrity key and the ranging encryption key according to the intermediate key and the random number.

The random number used in the process of determining the intermediate key based on the long-term key may be the same as or different from the random number used in the process of determining the ranging integrity key and the ranging encryption key based on the intermediate key.

The first UE 30 may determine, using a second sub-algorithm, the ranging integrity key and the ranging encryption key based on the intermediate key. The second sub-algorithm may be indicated by the core network 40, specified by the communication protocol, or agreed upon between the first UE 30 and the core network 40.

In one embodiment, determining the ranging integrity key and the ranging encryption key according to the intermediate key includes:
determining a session key based on the intermediate key; and
determining the ranging integrity key and the ranging encryption key according to the session key.

The first UE 30 may determine, using a third sub-algorithm, the session key based on the intermediate key. The third sub-algorithm may be indicated by the core network 40 or specified by the communication protocol. The third sub-algorithm may include determining the session key based on the intermediate key and the random number.

For example, the session key KD-sess may be determined based on the intermediate key KD, using, but not limited to, the following input parameters:
FC=0x5E
P0=random number_4
L0=length of the random number_4 (such as 0x00 0x10)
P1=Random Number_5 (such as a ranging service code)
L1=length of the random number_5 (such as 0x00 0x10)

The first UE 30 may determine, using a fourth sub-algorithm, the ranging integrity key and the ranging encryption key based on the session key. The fourth sub-algorithm may be indicated by the core network 40, specified by the communication protocol, or agreed upon between the first UE 30 and the core network 40.

The fourth sub-algorithm may include determining the ranging integrity key and the ranging encryption key based on the session key and the random number.

For example, the ranging integrity key (RIK) and the ranging encryption key (REK) may be determined based on the session key KD-sess, using, but not limited to, the following input parameters:
FC=0x5B
P0=0x01 (ranging integrity key) or 0x01 (ranging encryption key)
L0=length of P0 (such as 0x00 0x10)
P1=algorithm identifier
L1=length of the algorithm identifier (such as 0x00 0x10)

Here, the input key is 256-bit KD-sess. For an algorithm key with a length of n bits, where n is less than or equal to 256, the n least significant bits of the 256 bits output by the KDF are used as the algorithm key.

Here, the random numbers used in the first sub-algorithm, the second sub-algorithm, the third sub-algorithm and/or the fourth sub-algorithm may be different or the same. The security of the determined key may be improved by using different random numbers.

In addition, the first sub-algorithm, the second sub-algorithm, the third sub-algorithm, and the fourth sub-algorithm may be implemented separately, or some combinations of these sub-algorithms may be selected to be implemented as needed, which is not limited by the present disclosure.

In one embodiment, the method also includes:
sending a ranging announcement message that uses the ranging integrity key to carry out integrity protection on a direct link, wherein the ranging announcement message comprises at least one of:
indicated predetermined encrypted information that uses the ranging encryption key to carry out encryption protection; and
a long-term key identifier of the long-term key and the random number, where the long-term key identifier is determined based on the long-term key information.

Here, the first UE 30 sending a ranging announcement message on a direct link may include: sending a ranging announcement message on a PC5 port of the direct link.

Here, the long-term key identifier may be used to uniquely identify the long-term key. The long-term key identifier carried by the ranging announcement message is used to uniquely identify the long-term key used to generate the ranging integrity key and the ranging encryption key of the ranging announcement message. The random number carried by the ranging announcement message may be the random number used in the process of generating the ranging integrity key and the ranging encryption key using the long-term key. There may be one or more random numbers.

For example, the ranging announcement message may carry random numbers used in the first sub-algorithm, the second sub-algorithm, the third sub-algorithm, and/or the fourth sub-algorithm.

The first UE 30 sends a ranging announcement message on a direct link for reception by the second UE 32. The ranging announcement message may include a ranging requirement, a time stamp, a long-term key identifier, a random number, etc. Here, the second UE 32 may be the UE that maintains connected to the mobile communication network.

Here, the second UE 32 may monitor and receive the ranging announcement message on the direct link. The second UE 32 may monitor and receive the ranging announcement message on the PC5 port of the direct link.

For example, as shown in FIG. 5, after the first UE 30 obtains the long-term key information from the core network 40, and carries out integrity protection of the ranging announcement message and carries out encryption protection of the encrypted message by using the long-term key, the first UE 30 may execute Step 504: the first UE 30 issues the ranging announcement message that uses the ranging integrity key to carry out integrity protection on the direct link, and the encrypted message in the ranging announcement message carries out encryption protection by the ranging encryption key.

It is to be understood that the above Step 504 may be implemented alone, may be implemented in combination with Step 501 and Step 502/503, and the implementation sequence may be adjusted as needed, which is not limited by the present disclosure.

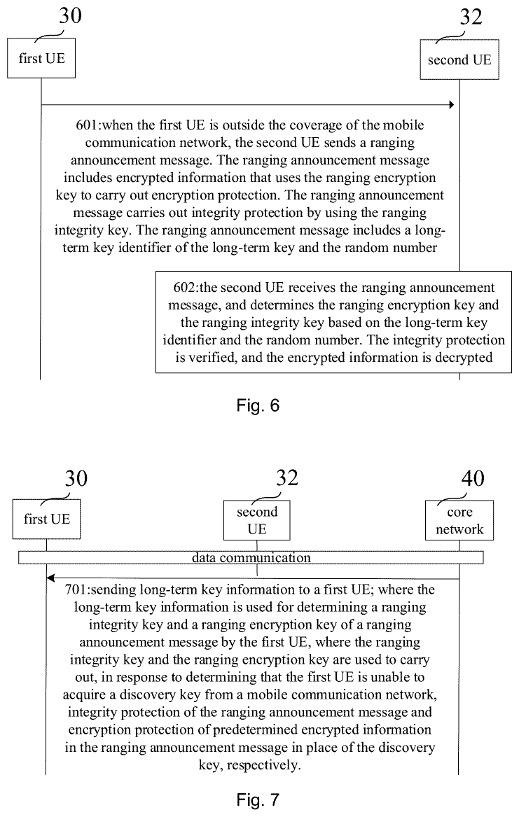

In one embodiment, as shown in FIG. 6, the first UE 30 sending a ranging announcement message to the second UE 32 includes the following specific steps.

Step 601: when the first UE 30 is outside the coverage of the mobile communication network, the first UE 30 sends a ranging announcement message. The ranging announcement message includes encrypted information that uses the ranging encryption key to carry out encryption protection. The ranging announcement message carries out integrity protection by using the ranging integrity key. The ranging announcement message includes a long-term key identifier of the long-term key and the random number.

Step 602: the second UE 32 receives the ranging announcement message, and determines the ranging encryption key and the ranging integrity key based on the long-term key identifier and the random number. The integrity protection is verified, and the encrypted information is decrypted.

The method for determining the ranging integrity key and the ranging encryption key can refer to the aforementioned embodiment, such as the embodiment shown in FIG. 5, which is not limited by the present disclosure. The long-term key identifier and the random number may be used by the second UE 32 to determine the ranging integrity key and the ranging encryption key of the ranging announcement message. The second UE 32 may determine the long-term key according to the long-term key identifier, for example, determine the long-term key through the pre-stored key list, or request a long-term key corresponding to the long-term key identifier from the core network 40. The second UE 32 can use the same algorithm as the first UE 30 to determine the ranging integrity key and the ranging encryption key through the long-term key and the random number, and then carry out integrity verification and decrypt the encrypted information of the ranging announcement message.

In one embodiment, the random numbers in the ranging announcement message may include: a random number used in the process of determining the intermediate key based on the long-term key, i.e., a random number used by the first sub-algorithm; and/or a random number used in the process of determining the ranging integrity key and the ranging encryption key based on the intermediate key, i.e., a random number used in the second sub-algorithm, the third sub-algorithm, and/or the fourth sub-algorithm.

The first UE 30 may send, on a direct link, a ranging announcement message that uses the ranging integrity key to carry out integrity protection.

After receiving the ranging announcement message, the second UE 32 may determine the long-term key according to the long-term key identifier in the ranging announcement message, for example, determine the long-term key through the pre-stored key list, or request a long-term key corresponding to the long-term key identifier from the core network 40. The second UE 32 can determine the ranging integrity key and the ranging encryption key through the long-term key using the same algorithm as the first UE 30, and then carry out integrity verification of the ranging announcement message and decrypt the encrypted information.

The second UE 32 may send the long-term key identifier and the random number to the core network 40, such as the RKMF.

The long-term key used by the first UE 30 to determine the ranging integrity key and the ranging encryption key is sent to the first UE 30 by the RKMF, and the RKMF may store the long-term key and the long-term key identifier of the long-term key.

Here, the random number sent to the core network 40 by the second UE 32 may be the random number used when determining the intermediate key based on the long-term key.

After receiving the long-term key identifier and the random number sent by the second UE 32, the core network 40 may determine the corresponding long-term key according to the long-term key identifier, and determine the intermediate key using an algorithm is the same as the first UE 30 determines the intermediate key, such as the above first preset algorithm.

The core network 40 may send the intermediate key to the second UE 32 after determining the intermediate key.

After receiving the intermediate key, the second UE 32 may determine the ranging integrity key and the ranging encryption key using an algorithm that the first UE 30 determines the ranging integrity key and the ranging encryption key according to the intermediate key, such as the above second preset algorithm.

In this way, the second UE 32 may determine the ranging integrity key and the ranging encryption key of the ranging announcement message.

In one embodiment, the second UE 32 determining the ranging integrity key and the ranging encryption key according to the intermediate key includes:
determining, by the second UE 32, a session key based on the intermediate key; and
determining, by the second UE 32, the ranging integrity key and the ranging encryption key according to the session key.

The manner in which the second UE 32 determines the session key based on the intermediate key and determines the ranging integrity key and the ranging encryption key according to the session key is similar to the manner in which the first UE 30 determines the session key based on the intermediate key and then determines the ranging integrity key and the ranging encryption key, which will not be described in detail here.

The algorithms used by the second UE 32 and the first UE 30 to determine the respective keys may be specified by the communication protocol, may be indicated by the core network 40, or may be pre-agreed upon between the core network 40 and the UE.

In one embodiment, the ranging announcement message also includes at least one of the following:
a time stamp that the first UE 30 sends the ranging announcement message;
an identifier of a ranging integrity algorithm that uses the ranging integrity key to carry out integrity protection;
an identifier of a ranging encryption algorithm that uses the ranging encryption key to carry out encryption protection; and
ranging requirements.

Here, the time stamp and the random number may be used by the second UE 32 to detect whether the ranging announcement message is replayed. Here, the ranging announcement message being replayed may include: after receiving the ranging announcement message, modifying, by a third party communication device, the ranging announcement message, and sending the ranging announcement message again. The replayed ranging announcement message is likely to be maliciously attacked, and thus, if the second UE 32 detects that the ranging announcement message is replayed, the ranging announcement message may be discarded.

The second UE 32 may detect the time stamp and the time at which the ranging announcement message is received, and if the time difference between the time stamp and the time is greater than a time threshold, it is determined that the ranging announcement message is replayed, otherwise, it is determined that the ranging announcement message is not replayed.

When receiving each ranging announcement message, the second UE 32 may store the random number in the ranging announcement message. If the received random number in the ranging announcement message is the same as the stored random number, it may be determined that the ranging announcement message is replayed, otherwise, it may be determined that the ranging announcement message is not replayed.

The time stamp and the random number can verify that the ranging announcement message is being replayed. In the process of detecting whether the ranging announcement message is replayed by using the time stamp and the random number, if any one of the results determines that the ranging announcement message is replayed, it is determined that the ranging announcement message is replayed. It is determined that the ranging announcement message is not replayed by using the results of the time stamp and the random number, respectively, so that it may be determined that the ranging announcement message is not replayed. Here, the random number for verifying whether the ranging announcement message is replayed may be the random number used in the process of determining the ranging integrity key and/or determining the ranging encryption key based on the long-term key.

In one embodiment, the second UE 32 determines, according to the identifier of the ranging integrity algorithm, the ranging integrity algorithm used by the ranging announcement message.

The second UE 32 can carry out integrity protection verification of the ranging announcement message based on the ranging integrity algorithm and the ranging integrity key.

The second UE 32 can carry out integrity protection verification of the ranging announcement message based on the ranging integrity algorithm and the ranging integrity key, includes:
the second UE 32 can carry out integrity protection verification of the ranging announcement message based on the ranging integrity algorithm, the ranging integrity key, and the random number for integrity protection.

In one embodiment, the second UE 32 determines, according to the identifier of the ranging encryption algorithm, the ranging encryption algorithm used by the encrypted information in the ranging announcement message.

The second UE 32 can decrypt the encrypted information based on the ranging encryption algorithm and the ranging encryption key.

The second UE 32 can decrypt the encrypted information based on the ranging encryption algorithm and the ranging encryption key, includes:
the second UE 32 can decrypt the encrypted information based on the ranging encryption algorithm, the ranging encryption key, and the random number for encryption protection.

In one embodiment, sending, on a direct link, a ranging announcement message that uses the ranging integrity key to carry out integrity protection includes:
in response to determining that the first UE 30 fails to connect to the mobile communication network, sending the ranging announcement message that uses the ranging integrity key to carry out integrity protection.

Here, when failing to connect to the mobile communication network, the first UE 30 can send the ranging announcement message that uses the ranging integrity key to carry out integrity protection, where the ranging announcement message includes encrypted information that uses the ranging encryption key to carry out encryption protection, where the ranging integrity key and the ranging encryption key are determined according to the long-term key.

The first UE 30 is unable to connect to the mobile communication network, and thus, the discovery key cannot be updated. The ranging integrity key and the ranging encryption key are determined by using the long-term key, and the ranging announcement message that uses the long-term key to determine the ranging integrity key to carry out integrity protection is sent. The encrypted message in the ranging announcement message is under encryption protection by using the ranging encryption key. The reliability of the ranging announcement message and the security of information are improved.

The ranging requirements may include: requirements from the first UE 30, such as ranging precision and time.

In one embodiment, the ranging announcement message also includes a first ranging restriction code, where the first ranging restriction code is used to identify the ranging announcement message.

The first ranging restriction code may, but is not limited to, be used to indicate an application type of the ranging announcement message at an application layer. The UE authorized to monitor the ranging announcement message corresponding to the first ranging restriction code needs to monitor the ranging announcement message including the first ranging restriction code.

The ranging announcement message may be triggered based on different applications. The first ranging restriction codes of the ranging announcement messages triggered by different types of applications may be different. Here, a first ranging application code is set in the ranging announcement message by the first UE 30.

In one embodiment, the second UE 32 sends, to the core network 40, a monitoring request that carries at least a ranging layer identifier of the second UE 32 at a ranging layer; the second UE 32 receives a second ranging restriction code sent by the core network 40 in response to the monitoring request, where the second ranging restriction code is used to indicate a ranging announcement message that the second UE 32 needs to monitor.

The ranging layer identifier of the second UE 32 may be used to uniquely identify the second UE 32 at the ranging layer.

The monitoring request may be used to request the RKMF to monitor the direct link. Here, monitoring the direct link may include monitoring the ranging announcement message on the direct link.

According to the monitoring request of the second UE 32, the RKMF authorizes the second UE 32 to monitor a specific ranging announcement message according to a service profile defined by the application layer. The RKMF may send a second ranging restriction code to the second UE 32, indicating a ranging announcement message that the second UE 32 needs to monitor. The RKMF may send the second ranging restriction code to the second UE 32 in response to the monitoring request. The RKMF may send one or more second ranging restriction codes to the second UE 32.

After receiving the ranging announcement message, the second UE 32 can compare the first ranging restriction code in the ranging announcement message with the second ranging restriction code sent to the second UE 32 by the core network 40. If the first ranging restriction code corresponds to the second ranging restriction code, it is determined that the ranging announcement message is the ranging announcement message that the second UE 32 needs to monitor. The second UE 32 may determine the ranging integrity key and the ranging encryption key of the ranging announcement message to be monitored.

When determining that the received ranging announcement message is the ranging announcement message that the second UE 32 needs to monitor, the second UE 32 may send, to the core network 40, the long-term key identifier in the ranging announcement message and the random number to request the core network 40 to determine the intermediate key.

In one embodiment, the second UE 32 verifies integrity of the ranging announcement message according to the ranging integrity key; and/or decrypts the predetermined encrypted information under encryption protection according to the ranging encryption key; and
the second UE 32 determines whether the ranging announcement message is accepted based on a result of validating integrity and/or a result of deciphering.

The second UE 32 verifies integrity of the ranging announcement message by using the ranging integrity key, and decrypts the encrypted information of the ranging announcement message by using the ranging encryption key.

If the integrity verification is successful, it may be determined that the ranging announcement message is not tampered with, or the ranging announcement message is transmitted correctly. The second UE 32 can accept the ranging announcement message, and decrypt the encrypted information of the ranging announcement message by using the ranging encryption key to acquire the encrypted information, such as ranging requirements. Response is made to the ranging announcement message of the first UE 30, such as sending a ranging signal.

If integrity verification and/or decryption fails, it may be determined that the ranging announcement message is tampered with or that the ranging announcement message is transmitted incorrectly. The second UE 32 may discard the ranging announcement message.

As shown in FIG. 7, the present illustrative example provides a method for transmitting information, performed by a core network 40 of a cellular mobile communication system, including the following step:

Step 701: sending long-term key information to a first UE 30;
where the long-term key information is used for the first UE 30 to determine a ranging integrity key and a ranging encryption key of a ranging announcement message, where the ranging integrity key and the ranging encryption key are used to carry out, in response to determining that the first UE 30 is unable to acquire a discovery key from a mobile communication network, integrity protection of the ranging announcement message and encryption protection of predetermined encrypted information in the ranging announcement message in place of the discovery key, respectively. Here, the management behaviors such as generation and distribution of Long-Term Keys (LTKs) may be carried out by a network element with a Ranging Key Management Function (RKMF) in a core network 40 such as a mobile communication network, such as a 5G cellular mobile communication network. The RKMF may send long-term key information to the UE upon request of the UE carrying out ranging. The long-term key information is unique to each UE requesting the long-term key.

The first UE 30 and the second UE 32 may be an observer UE or a target UE carrying out ranging, respectively. For example, the ranging announcement message may be sent by the target UE 2 for the observer UE 1 to discover messages from the target UE 2. the observer UE 1 can monitor the ranging announcement message and respond to the ranging announcement message that meets a response condition, thus completing the discovery of the target UE 2 by the observer UE 1. The first UE 30 may be a sending object of the ranging announcement message, and the second UE 32 may be a receiving object of the ranging announcement message. For example, the first UE 30 may be a target UE carrying out ranging, and the second UE 32 may be an observer UE carrying out ranging; alternatively, the first UE 30 may be an observer UE carrying out ranging, and the second UE 32 may be a target UE carrying out ranging.

The integrity protection of the ranging announcement message may be achieved in many ways such as generating unique ranging integrity information for the ranging announcement message by using a ranging integrity algorithm. The ranging integrity information may be computed using hash functions, etc. In the process of generating the ranging integrity information, the ranging integrity key may be added to provide security protection for the ranging integrity information. For example, before using the ranging integrity algorithm, the ranging integrity key may be added to the ranging announcement message to generate the encrypted ranging integrity information, or after generating the ranging integrity information by using the ranging integrity algorithm, the ranging integrity key may be used for encrypting the ranging integrity information.

The encryption protection of the ranging announcement message may be achieved by including predetermined encrypted information in the ranging announcement message, the predetermined encrypted information that needs to be encrypted using a ranging encryption key. The disclosure scope of the predetermined encrypted information is limited, and merely the UE with permission can read the predetermined encrypted information. The information content included in the predetermined encrypted information may be set in advance by a user, etc. The predetermined encrypted information may include ranging requirements such as ranging precision and ranging time.

Here, the ranging integrity key and the ranging encryption key may be determined according to the discovery key or may be determined according to the long-term key information. The discovery key may be a key used by the first UE 30 to send the ranging announcement message when the first UE 30 is connected to the mobile communication network. The discovery key may be directly used as a ranging integrity key and a ranging encryption key. However, the discovery key is time-effective. When the discovery key is invalid or unable to be updated in time, an updated discovery key may be determined according to the long-term key information, that is, the ranging integrity key and the ranging encryption key may be used as an alternative to the updated discovery key.

The long-term key information may be a ranging integrity key for determining to carry out the integrity protection of the ranging announcement message when the first UE 30 is unable to use the discovery key.

In one embodiment, the long-term key information includes at least the long-term key. Determining a ranging integrity key and a ranging encryption key of a ranging announcement message according to long-term key information sent by a core network 40 may include determining the ranging integrity key and the ranging encryption key of the ranging announcement message according to the long-term key.

For example, the first UE 30 may determine the ranging integrity key and the ranging encryption key based on a long-term key and a random number using a preset algorithm.

When the first UE 30 is connected to the mobile communication network, the discovery key provided by the core network 40 may be used to carry out encryption protection and integrity protection.

When the first UE 30 is unable to acquire the discovery key from the mobile communication network, or fails to acquire the discovery key, the long-term key may be used to determine the ranging integrity key and the ranging encryption key as an alternative to the discovery key. The first UE 30 can calculate the long-term key using a preset algorithm, so as to determine the ranging integrity key and the ranging encryption key. For example, a ranging integrity key and a ranging encryption key are determined through a logical operation, etc., between a long-term key and a random number.

The first UE 30 being unable to acquire a discovery key from a mobile communication network may include: the first UE 30 being outside the coverage of the mobile communication network, so that the discovery key cannot be obtained, etc.

The first UE 30 failing to acquire the discovery key may include: the core network 40 being unable to respond to the request of the first UE 30 to acquire the discovery key due to the load, etc.

In one embodiment, the first UE 30 being unable to acquire a discovery key from a mobile communication network includes: the first UE 30 being disconnected from the mobile communication network when the discovery key obtained from the mobile communication network is invalidated.

Under the coverage of the mobile communication network, the discovery key sent by the core network 40 to the first UE 30 is time-effective. After the discovery key expires, the discovery key will be invalidated. When the first UE 30 is disconnected from the mobile communication network and the discovery key is found to be invalidated, the first UE 30 cannot use the discovery key. The first UE 30 can use the long-term key to determine the ranging integrity key and the ranging encryption key, thus achieving the integrity protection of the ranging announcement message and the encryption protection of the predetermined encrypted information.

The first UE 30 may receive the long-term key information sent by the core network 40 within the mobile communication network. The long-term key information may be used for determining the long-term key by the first UE 30.

For example, the long-term key information may be an algorithm, a parameter, etc., for calculating the long-term key. The first UE 30 may acquire the long-term key information from the core network 40 while maintaining connected to the mobile communication network.

In one embodiment, the long-term key information includes the long-term key and/or a long-term key identifier of the long-term key.

The core network 40 can merely send the long-term key to the first UE 30, and the first UE 30 can query the long-term key identifier corresponding to the long-term key from a pre-stored key list. The core network 40 can also merely send the long-term key identifier to the first UE 30, and the first UE 30 can query the long-term key corresponding to the long-term key from the pre-stored key list. The key list may be sent by the core network 40 to the first UE 30 in advance, may be pre-agreed upon by the protocol, or may be obtained by the first UE 30 in other manners, which will not be limited in the present disclosure. The key list may include a corresponding relationship between the long-term key identifier and the long-term key. Here, the long-term key identifier may be used to uniquely identify the long-term key.

Optionally, the core network 40 may also send the long-term key and the long-term key identifier of the long-term key to the first UE 30.

After the core network 40 sends the long-term key information to the first UE 30, the long-term key information may be stored.

When the first UE 30 sends the ranging announcement message, the long-term key identifier may be included in the ranging announcement message for the core network 40, such as the RKMF, to determine the long-term key used by the ranging integrity key and the ranging encryption key of the ranging announcement message.

In one embodiment, the sending long-term key information to a first UE 30 includes:
sending the long-term key information to the first UE 30 through the mobile communication network in response to determining that the first UE 30 has a ranging layer identifier corresponding to the first UE 30 at a ranging layer.

The first UE 30 may send a long-term key request to the core network 40 to request the core network 40 to send information related to the long-term secret key, such as long-term secret key information, where the long-term key request may carry a ranging layer identifier corresponding to the first UE 30. The ranging layer identifier may be configured for the first UE 30 when the first UE 30 carries out ranging layer authentication. The ranging layer identifier may be configured for the first UE 30 by a core network 40, etc. The ranging layer identifier may be used to characterize that the first UE 30 has the authority to send a ranging announcement message. When the first UE 30 has a ranging layer identifier, it is indicated that the first UE 30 has the authority to send a ranging announcement message, and the core network 40 can send the long-term key information to the first UE 30 for the first UE 30 to carry out the integrity protection of the ranging announcement message and the encryption protection of the encrypted message.

In this way, through the long-term key information sent by the core network 40, the first UE 30 can determine the ranging integrity key and the ranging encryption key by using the long-term key information when the discovery key cannot be used to carry out integrity protection of the ranging announcement message and when the discovery key cannot be used to carry out encryption protection of the encrypted information, so as to achieve the integrity protection of the ranging announcement message and the encryption protection of the encrypted information. In this way, when a data transmission error or tampering occurs in the ranging announcement message in the transmission process, the data transmission error or tampering may be found in time, thus improving the reliability of transmitting the ranging announcement message and improving the security of encrypted information.

In one embodiment, the first UE 30 determines an intermediate key based on the long-term key and a random number; and determines the ranging integrity key and the ranging encryption key according to the intermediate key.

Here, algorithms for calculating the ranging integrity key and the ranging encryption key by the first UE 30 may be the same or different. The ranging integrity key and the ranging encryption key may be generated respectively by the same algorithm but with different algorithm parameters, such as random numbers.

The first UE 30 determines the ranging integrity key and the ranging encryption key based on a long-term key and a random number using a preset algorithm. The first UE 30 may also first determine an intermediate key using a preset algorithm, and then determine the ranging integrity key and the ranging encryption key through the intermediate key.

The first UE 30 may determine an intermediate key based on a long-term key and a random number by using a first sub-algorithm. The first sub-algorithm may be indicated by the core network 40, specified by the communication protocol, or agreed upon between the first UE 30 and the core network 40.

Here, there may be one or more random numbers for determining the intermediate key. The long-term key and the intermediate key may have a plurality of bits. For example, the long-term key and the intermediate key may both have 256 bits.

For example, the intermediate key KD may be determined based on the long-term key and a random number, using, but not limited to, the following input parameters:
FC=0x58
P0=random number_1 (such as a ranging layer identifier)
L0=length of the random number_1 (such as 0x00 0x03)
P1=random number_2 (such as a ranging service code)
L1=length of the random number_2 (such as 0x00 0x10)
P2=random number_3 (optional)
L2=length of the random number_3 (such as 0x00 0x10)

In one embodiment, determining the ranging integrity key and the ranging encryption key according to the intermediate key includes: determine, using a second sub-algorithm, the ranging integrity key and the ranging encryption key according to the intermediate key and the random number.

The random number used in the process of determining the intermediate key based on the long-term key may be the same as or different from the random number used in the process of determining the ranging integrity key and the ranging encryption key based on the intermediate key.

The first UE 30 may determine, using a second sub-algorithm, the ranging integrity key and the ranging encryption key based on the intermediate key. The second sub-algorithm may be indicated by the core network 40, specified by the communication protocol, or agreed upon between the first UE 30 and the core network 40.

In one embodiment, determining the ranging integrity key and the ranging encryption key according to the intermediate key includes:
determining a session key based on the intermediate key; and
determining the ranging integrity key and the ranging encryption key according to the session key.

The first UE 30 may determine, using a third sub-algorithm, the session key based on the intermediate key. The third sub-algorithm may be indicated by the core network 40 or specified by the communication protocol. A third sub-algorithm may include determining the session key based on the intermediate key and the random number.

For example, the session key KD-sess may be determined based on the intermediate key KD, using, but not limited to, the following input parameters:
FC=0x5E
P0=random number_4
L0=length of the random number_4 (such as 0x00 0x10)
P1=random number_5 (such as a ranging service code)
L1=length of the random number_5 (such as 0x00 0x10)

The first UE 30 may determine, using a fourth sub-algorithm, the ranging integrity key and the ranging encryption key based on the session key. The fourth sub-algorithm may be indicated by the core network 40, specified by the communication protocol, or agreed upon between the first UE 30 and the core network 40.

The fourth sub-algorithm may include determining the ranging integrity key and the ranging encryption key based on the session key and the random number.

For example, the ranging integrity key (RIK) and the ranging encryption key (REK) may be determined based on the session key KD-sess, using, but not limited to, the following input parameters:
FC=0x5B
P0=0x01 (ranging integrity key) or 0x01 (ranging encryption key)
L0=length of P0 (such as 0x00 0x10) P1=algorithm identifier
L1=length of the algorithm identifier (such as 0x00 0x10)

Here, the input key is 256-bit KD-sess. For an algorithm key with a length of n bits, where n is less than or equal to 256, the n least significant bits of the 256 bits output by the KDF are used as the algorithm key.

Here, the random numbers used in the first sub-algorithm, the second sub-algorithm, the third sub-algorithm and/or the fourth sub-algorithm may be different or the same. The security of the determined key may be improved by using different random numbers.

In addition, the first sub-algorithm, the second sub-algorithm, the third sub-algorithm, and the fourth sub-algorithm may be implemented separately, or some combinations of these sub-algorithms may be selected to be implemented as needed, which is not limited by the present disclosure.

In one embodiment, the first UE 30 sends, on a direct link, a ranging announcement message that uses the ranging integrity key to carry out integrity protection, where the ranging announcement message includes at least one of the following:
indicated predetermined encrypted information that uses the ranging encryption key to carry out encryption protection; and
a long-term key identifier of the long-term key and the random number, where the long-term key identifier is determined based on the long-term key information.

Here, the first UE 30 sending a ranging announcement message on a direct link may include: sending a ranging announcement message on a PC5 port of the direct link.

Here, the long-term key identifier may be used to uniquely identify the long-term key. The long-term key identifier carried by the ranging announcement message is used to uniquely identify the long-term key used to generate the ranging integrity key and the ranging encryption key of the ranging announcement message. The random number carried by the ranging announcement message may be the random number used in the process of generating the ranging integrity key and the ranging encryption key using the long-term key. There may be one or more random numbers.

For example, the ranging announcement message may carry random numbers used in the first sub-algorithm, the second sub-algorithm, the third sub-algorithm, and/or the fourth sub-algorithm.

The first UE 30 sends a ranging announcement message on a direct link for reception by the second UE 32. The ranging announcement message may include a ranging requirement, a time stamp, a long-term key identifier, a random number, etc. Here, the second UE 32 may be the UE that maintains connected to the mobile communication network.

Here, the second UE 32 may monitor and receive the ranging announcement message on the direct link. The second UE 32 may monitor and receive the ranging announcement message on the PC5 port of the direct link.

In one embodiment, the method also includes:
receiving the long-term key identifier sent by a second UE 32 through the mobile communication network, and a random number;
determining an intermediate key based on a long-term key corresponding to the long-term key identifier and the random number; and
sending the intermediate key to the second UE 32 through the mobile communication network.

The second UE 32 may send the long-term key identifier and the random number in the ranging announcement message to the core network 40, such as the RKMF.

The long-term key used by the first UE 30 to determine the ranging integrity key and the ranging encryption key is sent to the first UE 30 by the RKMF, and the RKMF may store the long-term key and the long-term key identifier of the long-term key.

Here, the random number sent to the core network 40 by the second UE 32 may be the random number used when determining the intermediate key based on the long-term key.

After receiving the long-term key identifier and the random number sent by the second UE 32, the core network 40 may determine the corresponding long-term key according to the long-term key identifier, and determine the intermediate key using an algorithm is the same as the first UE 30 determines that the intermediate key, such as the above first preset algorithm.

The core network 40 may send the intermediate key to the second UE 32 after determining the intermediate key.

After receiving the intermediate key, the second UE 32 may determine the ranging integrity key and the ranging encryption key using an algorithm that the first UE 30 determines the ranging integrity key and the ranging encryption key according to the intermediate key, such as the above second preset algorithm.

In this way, the second UE 32 may determine the ranging integrity key and the ranging encryption key of the ranging announcement message.

In one embodiment, the second UE 32 determining the ranging integrity key and the ranging encryption key according to the intermediate key includes:
determining, by the second UE 32, a session key based on the intermediate key; and
determining, by the second UE 32, the ranging integrity key according to the session key.

The manner in which the second UE 32 determines the session key based on the intermediate key and determines the ranging integrity key and the ranging encryption key according to the session key is similar to the manner in which the first UE 30 determines the session key based on the intermediate key and then determines the ranging integrity key and the ranging encryption key, which will not be described in detail here.

The algorithms used by the second UE 32 and the first UE 30 to determine the respective keys may be specified by the communication protocol, may be indicated by the core network 40, or may be pre-agreed upon between the core network 40 and the UE.

In one embodiment, the method also includes:
receiving a monitoring request which is sent by the second UE 32 through the mobile communication network and carries at least the ranging layer identifier of the second UE 32; and
in response to determining that the second UE 32 is allowed to monitor the ranging announcement message based on an application layer rule, sending a second ranging restriction code to the second UE 32 through the mobile communication network, where the second ranging restriction code is used to indicate the ranging announcement message that the second UE 32 needs to monitor.

The ranging layer identifier of the second UE 32 may be used to uniquely identify the second UE 32 at the ranging layer.

The monitoring request may be used to request the RKMF to monitor the direct link. Here, monitoring the direct link may include monitoring the ranging announcement message on the direct link.

According to the monitoring request of the second UE 32, the RKMF authorizes the second UE 32 to monitor a specific ranging announcement message according to a service profile defined by the application layer. The RKMF may send a second ranging restriction code to the second UE 32, indicating a ranging announcement message that the second UE 32 needs to monitor. The RKMF may send the second ranging restriction code to the second UE 32 in response to the monitoring request. The RKMF may send one or more second ranging restriction codes to the second UE 32.

After receiving the ranging announcement message, the second UE 32 can compare the first ranging restriction code in the ranging announcement message with the second ranging restriction code sent to the second UE 32 by the core network 40. If the first ranging restriction code corresponds to the second ranging restriction code, it is determined that the ranging announcement message is the ranging announcement message that the second UE 32 needs to monitor. The second UE 32 may determine the ranging integrity key of the ranging announcement message to be monitored.

When determining that the received ranging announcement message is the ranging announcement message that the second UE 32 needs to monitor, the second UE 32 may send, to the core network 40, the long-term key identifier in the ranging announcement message and the random number to request the core network 40 to determine the intermediate key.

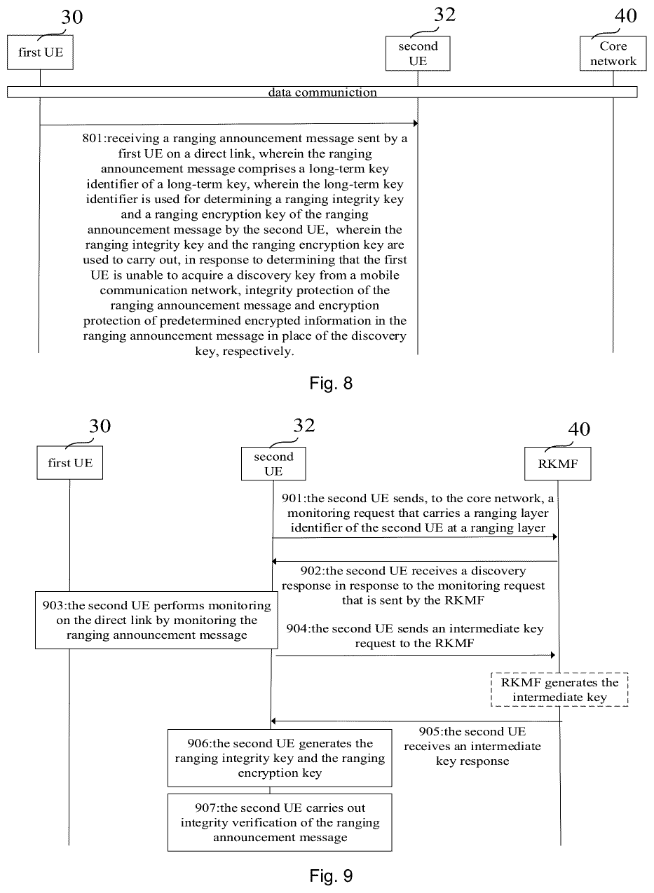

As shown in FIG. 8, the present illustrative example provides a method for transmitting information, performed by a second UE 32 of a cellular mobile communication system, including the following step:

Step 801: receiving a ranging announcement message sent by a first UE 30 on a direct link, where the ranging announcement message includes a long-term key identifier of a long-term key, where the long-term key identifier is used for determining a ranging integrity key and a ranging encryption key of the ranging announcement message by the second UE 32, wherein the ranging integrity key and the ranging encryption key are used to carry out, in response to determining that the first UE 30 is unable to acquire a discovery key from a mobile communication network, integrity protection of the ranging announcement message and encryption protection of predetermined encrypted information in the ranging announcement message in place of the discovery key, respectively.

Here, the management behaviors such as generation and distribution of Long-Term Keys (LTKs) may be carried out by a network element with a Ranging Key Management Function (RKMF) in a core network 40 such as a mobile communication network, such as a 5G cellular mobile communication network. The RKMF may send long-term key information to the UE upon request of the UE carrying out ranging. The long-term key information is unique to each UE requesting the long-term key.

The first UE 30 and the second UE 32 may be an observer UE or a target UE carrying out ranging, respectively. For example, the ranging announcement message may be sent by the target UE 2 for the observer UE 1 to discover messages from the target UE 2. the observer UE 1 can monitor the ranging announcement message and respond to the ranging announcement message that meets a response condition, thus completing the discovery of the target UE 2 by the observer UE 1. The first UE 30 may be a sending object of the ranging announcement message, and the second UE 32 may be a receiving object of the ranging announcement message. For example, the first UE 30 may be a target UE carrying out ranging, and the second UE 32 may be an observer UE carrying out ranging; alternatively, the first UE 30 may be an observer UE carrying out ranging, and the second UE 32 may be a target UE carrying out ranging.

The integrity protection of the ranging announcement message may be achieved in many ways such as generating unique ranging integrity information for the ranging announcement message by using a ranging integrity algorithm. The ranging integrity information may be computed using hash functions, etc. In the process of generating the ranging integrity information, the ranging integrity key may be added to provide security protection for the ranging integrity information. For example, before using the ranging integrity algorithm, the ranging integrity key may be added to the ranging announcement message to generate the encrypted ranging integrity information, or after generating the ranging integrity information by using the ranging integrity algorithm, the ranging integrity key may be used for encrypting the ranging integrity information.

The encryption protection of the ranging announcement message may be achieved by including predetermined encrypted information in the ranging announcement message, the predetermined encrypted information that needs to be encrypted using a ranging encryption key. The disclosure scope of the predetermined encrypted information is limited, and merely the UE with permission can read the predetermined encrypted information. The information content included in the predetermined encrypted information may be set in advance by a user, etc. The predetermined encrypted information may include ranging requirements such as ranging precision and ranging time.

Here, the ranging integrity key and the ranging encryption key may be determined according to the discovery key or may be determined according to the long-term key information. The discovery key may be a key used by the first UE 30 to send the ranging announcement message when the first UE 30 is connected to the mobile communication network. The discovery key may be directly used as a ranging integrity key and a ranging encryption key. However, the discovery key is time-effective. When the discovery key is invalid or unable to be updated in time, the updated discovery key may be determined according to the long-term key information, that is, the ranging integrity key and the ranging encryption key may be used as an alternative to the updated discovery key.

The long-term key information may be a ranging integrity key for determining to carry out the integrity protection of the ranging announcement message when the first UE 30 is unable to use the discovery key, and may be a ranging encryption key used to carry out encryption protection of the predetermined encrypted information.

In one embodiment, the long-term key information includes at least the long-term key. Determining a ranging integrity key and a ranging encryption key of a ranging announcement message according to long-term key information sent by a core network 40 may include determining the ranging integrity key and the ranging encryption key of the ranging announcement message according to the long-term key.

For example, the first UE 30 may determine the ranging integrity key and the ranging encryption key based on a long-term key and a random number using a preset algorithm.

When the first UE 30 remains connected to the mobile communication network, the discovery key provided by the core network 40 may be used to carry out encryption protection and integrity protection.

When the first UE 30 is unable to acquire the discovery key from the mobile communication network, or fails to acquire the discovery key, the long-term key may be used to determine the ranging integrity key and the ranging encryption key as an alternative to the discovery key. The first UE 30 can calculate the long-term key using a preset algorithm, so as to determine the ranging integrity key and the ranging encryption key. For example, a ranging integrity key and a ranging encryption key are determined through a logical operation, etc., between a long-term key and a random number.

The first UE 30 being unable to acquire a discovery key from a mobile communication network may include: the first UE 30 being outside the coverage of the mobile communication network, so that the discovery key cannot be obtained, etc.

The first UE 30 failing acquire the discovery key may include: the core network 40 being unable to respond to the request of the first UE 30 to acquire the discovery key due to the load, etc.

In one embodiment, the first UE 30 being unable to acquire a discovery key from a mobile communication network includes: the first UE 30 being disconnected from the mobile communication network when the discovery key obtained from the mobile communication network is invalidated.

Under the coverage of the mobile communication network, the discovery key sent by the core network 40 to the first UE 30 is time-effective. After the discovery key expires, the discovery key will be invalidated. When the first UE 30 is disconnected from the mobile communication network and the discovery key is found to be invalidated, the first UE 30 cannot use the discovery key. The first UE 30 can use the long-term key to determine the ranging integrity key and the ranging encryption key, thus achieving the integrity protection of the ranging announcement message and the encryption protection of the predetermined encrypted information.

The first UE 30 may send, on a direct link, a ranging announcement message that uses the ranging integrity key to carry out integrity protection.

After receiving the ranging announcement message, the second UE 32 may determine the long-term key according to the long-term key identifier in the ranging announcement message, for example, determine the long-term key through the pre-stored key list, or request a long-term key corresponding to the long-term key identifier from the core network 40. The second UE 32 can determine the ranging integrity key and the ranging encryption key through the long-term key using the same algorithm as the first UE 30, and then carry out integrity verification of the ranging announcement message.

In this way, through the long-term key information sent by the core network 40, the first UE 30 can determine the ranging integrity key and the ranging encryption key by using the long-term key information when the discovery key cannot be used to carry out integrity protection of the ranging announcement message and when the discovery key cannot be used to carry out encryption protection of the encrypted information, so as to achieve the integrity protection of the ranging announcement message and the encryption protection of the encrypted information. In this way, when a data transmission error or tampering occurs in the ranging announcement message in the transmission process, the data transmission error or tampering may be found in time, thus improving the reliability of transmitting the ranging announcement message and improving the security of encrypted information.

In one embodiment, the ranging announcement message also includes a random number, and
the method also includes:
sending the long-term key identifier and the random number to a core network 40;
receiving an intermediate key sent by the core network 40 through the mobile communication network in response to the long-term key identifier and the random number; and
determining the ranging integrity key and the ranging encryption key according to the intermediate key.

Here, algorithms for calculating the ranging integrity key and the ranging encryption key by the first UE 30 may be the same or different. The ranging integrity key and the ranging encryption key may be generated by the same algorithm but with different algorithm parameters, such as random numbers.

The first UE 30 determines the ranging integrity key and the ranging encryption key based on a long-term key and a random number using a preset algorithm. The first UE 30 may also first determine an intermediate key using a preset algorithm, and then determine the ranging integrity key and the ranging encryption key according to the intermediate key.

The first UE 30 may determine an intermediate key based on a long-term key and a random number by using a first sub-algorithm. The first sub-algorithm may be indicated by the core network 40, specified by the communication protocol, or agreed upon between the first UE 30 and the core network 40.

Here, there may be one or more random numbers for determining the intermediate key. The long-term key and the intermediate key may have a plurality of bits. For example, the long-term key and the intermediate key may both have 256 bits.

For example, the intermediate key KD may be determined based on the long-term key and a random number, using, but not limited to, the following input parameters:
FC=0x58
P0=random number_1 (such as a ranging layer identifier)
L0=length of the random number_1 (such as 0x00 0x03)
P1=random number_2 (such as a ranging service code)
L1=length of the random number_2 (such as 0x00 0x10) P2=random number_3 (optional)
L2=length of the random number_3 (such as 0x00 0x10)

In one embodiment, determining the ranging integrity key and the ranging encryption key according to the intermediate key includes: determining, using a second sub-algorithm, the ranging integrity key and the ranging encryption key according to the intermediate key and the random number.

The random number used in the process of determining the intermediate key based on the long-term key may be the same as or different from the random number used in the process of determining the ranging integrity key and the ranging encryption key based on the intermediate key.

The first UE 30 may determine, using a second sub-algorithm, the ranging integrity key and the ranging encryption key based on the intermediate key. The second sub-algorithm may be indicated by the core network 40, specified by the communication protocol, or agreed upon between the first UE 30 and the core network 40.

In one embodiment, determining the ranging integrity key and the ranging encryption key according to the intermediate key includes:
determining a session key based on the intermediate key; and
determining the ranging integrity key and the ranging encryption key according to the session key.

The first UE 30 may determine, using a third sub-algorithm, the session key based on the intermediate key. The third sub-algorithm may be indicated by the core network 40 or specified by the communication protocol. The third sub-algorithm may include determining the session key based on the intermediate key and the random number.

For example, the session key KD-sess may be determined based on the intermediate key KD, using, but not limited to, the following input parameters:
FC=0x5E
P0=random number_4
L0=length of the random number_4 (such as 0x00 0x10)
P1=random number_5 (such as a ranging service code)
L1=length of the random number_5 (such as 0x00 0x10)

The first UE 30 may determine, using a fourth sub-algorithm, the ranging integrity key and the ranging encryption key based on the session key. The fourth sub-algorithm may be indicated by the core network 40, specified by the communication protocol, or agreed upon between the first UE 30 and the core network 40.

The fourth sub-algorithm may include determining the ranging integrity key and the ranging encryption key based on the session key and the random number.

For example, the ranging integrity key (RIK) and the ranging encryption key (REK) may be determined based on the session key KD-sess, using, but not limited to, the following input parameters:
FC=0x5B
P0=0x01 (ranging integrity key) or 0x01 (ranging encryption key)
L0=length of P0 (such as 0x00 0x10)
P1=algorithm identifier
L1=length of the algorithm identifier (such as 0x00 0x10)

Here, the input key is 256-bit KD-sess. For an algorithm key with a length of n bits, where n is less than or equal to 256, the n least significant bits of the 256 bits output by the KDF are used as the algorithm key.

Here, the random numbers used in the first sub-algorithm, the second sub-algorithm, the third sub-algorithm and/or the fourth sub-algorithm may be different or the same. The security of the determined key may be improved by using different random numbers.

In addition, the first sub-algorithm, the second sub-algorithm, the third sub-algorithm, and the fourth sub-algorithm may be implemented separately, or some combinations of these sub-algorithms may be selected to be implemented as needed, which is not limited by the present disclosure.

Here, the first UE 30 sending a ranging announcement message on a direct link may include: sending a ranging announcement message on a PC5 port of the direct link.

Here, the long-term key identifier may be used to uniquely identify the long-term key. The long-term key identifier carried by the ranging announcement message is used to uniquely identify the long-term key used to generate the ranging integrity key and the ranging encryption key of the ranging announcement message. The random number carried by the ranging announcement message may be the random number used in the process of generating the ranging integrity key and the ranging encryption key using the long-term key. There may be one or more random numbers.

For example, the ranging announcement message may carry the random numbers used in the first sub-algorithm, the second sub-algorithm, the third sub-algorithm, and/or the fourth sub-algorithm.

The first UE 30 sends a ranging announcement message on a direct link for reception by the second UE 32. The ranging announcement message may include a ranging requirement, a time stamp, a long-term key identifier, a random number, etc. Here, the second UE 32 may be the UE that maintains connected to the mobile communication network.

Here, the second UE 32 may monitor and receive the ranging announcement message on the direct link. The second UE 32 may monitor and receive the ranging announcement message on the PC5 port of the direct link.

The long-term key identifier and the random number may be used by the second UE 32 to determine the ranging integrity key and the ranging encryption key of the ranging announcement message. The second UE 32 may determine the long-term key according to the long-term key identifier, for example, determine the long-term key through the pre-stored key list, or request a long-term key corresponding to the long-term key identifier from the core network 40. The second UE 32 can use the same algorithm as the first UE 30 to determine the ranging integrity key and the ranging encryption key through the long-term key and the random number, and then carry out integrity verification and decrypt the encrypted information of the ranging announcement message.

In one embodiment, the random number in the ranging announcement message may include: a random number used in the process of determining the intermediate key based on the long-term key, i.e., a random number used by the first sub-algorithm; and/or a random number used in the process of determining the ranging integrity key and the ranging encryption key based on the intermediate key, i.e., a random number used in the second sub-algorithm, the third sub-algorithm, and/or the fourth sub-algorithm.

Here, the random number in the ranging announcement message may be the random number used by the first UE 30 to determine the ranging integrity key and the ranging encryption key in combination with the long-term key. The ranging announcement message may include one or more random numbers.

In one embodiment, the random numbers sent to the core network 40 may include the random number used in the process of determining the intermediate key based on the long-term key, and/or the random number used in the process of determining the ranging integrity key based on the intermediate key.

The second UE 32 may send the long-term key identifier and the random number to the core network 40, such as the RKMF.

The long-term key used by the first UE 30 to determine the ranging integrity key and the ranging encryption key is sent to the first UE 30 by the RKMF, and the RKMF may store the long-term key and the long-term key identifier of the long-term key.

Here, the random number sent to the core network 40 by the second UE 32 may be the random number used when determining the intermediate key based on the long-term key.

After receiving the long-term key identifier and the random number sent by the second UE 32, the core network 40 may determine the corresponding long-term key according to the long-term key identifier, and determine the intermediate key using an algorithm is the same as the first UE 30 determines the intermediate key, such as the above first preset algorithm.

The core network 40 may send the intermediate key to the second UE 32 after determining the intermediate key.

After receiving the intermediate key, the second UE 32 may determine the ranging integrity key and the ranging encryption key using an algorithm that the first UE 30 determines the ranging integrity key and the ranging encryption key according to the intermediate key, such as the above second preset algorithm.

In this way, the second UE 32 may determine the ranging integrity key and the ranging encryption key of the ranging announcement message.

In one embodiment, as shown in FIG. 6, the first UE 30 sending a ranging announcement message to the second UE 32 includes the following specific steps.

Step 601: when the first UE 30 is outside the coverage of the mobile communication network, the first UE 30 sends a ranging announcement message. The ranging announcement message includes encrypted information that uses the ranging encryption key to carry out encryption protection. The ranging announcement message uses the ranging integrity key to carry out integrity protection. The ranging announcement message includes a long-term key identifier of the long-term key and the random number.

Step 602: the second UE 32 receives the ranging announcement message, and determines the ranging encryption key and the ranging integrity key based on the long-term key identifier and the random number. The integrity protection is verified, and the encrypted information is decrypted.

The method for determining the ranging integrity key and the ranging encryption key can refer to the aforementioned embodiment, such as the embodiment shown in FIG. 5, which is not limited by the present disclosure.

In one embodiment, the second UE 32 determining the ranging integrity key and the ranging encryption key according to the intermediate key includes:
determining, by the second UE 32, a session key based on the intermediate key; and
determining, by the second UE 32, the ranging integrity key and the ranging encryption key according to the session key.

The manner in which the second UE 32 determines the session key based on the intermediate key and determines the ranging integrity key and the ranging encryption key according to the session key is similar to the manner in which the first UE 30 determines the session key based on the intermediate key and then determines the ranging integrity key and the ranging encryption key, which will not be described in detail here.

The algorithms used by the second UE 32 and the first UE 30 to determine the respective keys may be specified by the communication protocol, may be indicated by the core network 40, or may be pre-agreed upon between the core network 40 and the UE.

In one embodiment, the ranging announcement message also includes at least one of the following:
a time stamp that the first UE 30 sends the ranging announcement message;
an identifier of a ranging integrity algorithm that uses the ranging integrity key to carry out integrity protection;
an identifier of a ranging encryption algorithm that uses the ranging encryption key to carry out encryption protection; and
ranging requirements.

Here, the time stamp and the random number may be used by the second UE 32 to detect whether the ranging announcement message is replayed. Here, the ranging announcement message being replayed may include: after receiving the ranging announcement message, modifying, by a third party communication device, the ranging announcement message, and sending the ranging announcement message again. The replayed ranging announcement message is likely to be maliciously attacked, and thus, if the second UE 32 detects that the ranging announcement message is replayed, the ranging announcement message may be discarded.

In one embodiment, the method also includes:
determining whether the ranging announcement message is replayed based on the time stamp and/or the random number.

The second UE 32 may detect the time stamp and the time at which the ranging announcement message is received, and if the time difference between the time stamp and the time is greater than a time threshold, it is determined that the ranging announcement message is replayed, otherwise, it is determined that the ranging announcement message is not replayed.

When receiving each ranging announcement message, the second UE 32 may store the random number in the ranging announcement message. If the received random number in the ranging announcement message is the same as the stored random number, it may be determined that the ranging announcement message is replayed, otherwise, it may be determined that the ranging announcement message is not replayed.

The time stamp and the random number can verify that the ranging announcement message is being replayed. In the process of detecting whether the ranging announcement message is replayed by using the time stamp and the random number, if any one of the results determines that the ranging announcement message is replayed, it is determined that the ranging announcement message is replayed. It is determined that the ranging announcement message is not replayed by using the results of the time stamp and the random number, respectively, so that it may be determined that the ranging announcement message is not replayed. Here, the random number for verifying whether the ranging announcement message is replayed may be the random number used in the process of determining the ranging integrity key and/or determining the ranging encryption key based on the long-term key.

The ranging requirements may include: requirements from the first UE 30, such as ranging precision and time.

In one embodiment, the second UE 32 determines, according to the identifier of the ranging integrity algorithm, the ranging integrity algorithm used by the ranging announcement message.

The second UE 32 can carry out integrity protection verification of the ranging announcement message based on the ranging integrity algorithm and the ranging integrity key.

The second UE 32 can carry out integrity protection verification of the ranging announcement message based on the ranging integrity algorithm and the ranging integrity key, includes:
the second UE 32 can carry out integrity protection verification of the ranging announcement message based on the ranging integrity algorithm, the ranging integrity key, and the random number for integrity protection.

In one embodiment, the second UE 32 determines, according to the identifier of the ranging encryption algorithm, the ranging encryption algorithm used by the encrypted information in the ranging announcement message.

The second UE 32 can decrypt the encrypted information based on the ranging encryption algorithm and the ranging encryption key.

The second UE 32 can decrypt the encrypted information based on the ranging encryption algorithm and the ranging encryption key, includes:
the second UE 32 can decrypt the encrypted information based on the ranging encryption algorithm, the ranging encryption key, and the random number for encryption protection.

In one embodiment, the ranging announcement message also includes a first ranging restriction code, where the first ranging restriction code is used to identify the ranging announcement message. The first ranging restriction code may, but is not limited to, be used to indicate an application type of the ranging announcement message at an application layer. The UE authorized to monitor the ranging announcement message corresponding to the first ranging restriction code needs to monitor the ranging announcement message including the first ranging restriction code.

The ranging announcement message may be triggered based on different applications. The first ranging restriction codes of the ranging announcement messages triggered by different types of applications may be different. Here, a first ranging application code is set in the ranging announcement message by the first UE 30.

In one embodiment, the method also includes:
sending, to the core network 40, a monitoring request that carries at least a ranging layer identifier of the second UE 32 at a ranging layer; and
receiving a second ranging restriction code sent by the core network 40 in response to the monitoring request, where the second ranging restriction code is used to indicate the ranging announcement message that the second UE 32 needs to monitor.

The ranging layer identifier of the second UE 32 may be used to uniquely identify the second UE 32 at the ranging layer.

The monitoring request may be used to request the RKMF to monitor the direct link. Here, monitoring the direct link may include monitoring the ranging announcement message on the direct link.

According to the monitoring request of the second UE 32, the RKMF authorizes the second UE 32 to monitor a specific ranging announcement message according to a service profile defined by the application layer. The RKMF may send a second ranging restriction code to the second UE 32, indicating a ranging announcement message that the second UE 32 needs to monitor. The RKMF may send the second ranging restriction code to the second UE 32 in response to the monitoring request. The RKMF may send one or more second ranging restriction codes to the second UE 32.

In one embodiment, the receiving an intermediate key sent by the core network 40 through the mobile communication network in response to the long-term key identifier and the ranging session random number includes:
sending the long-term key identifier and the ranging session random number to the core network 40 in response to determining that a first ranging restriction code in the ranging announcement message has a corresponding relationship with the second ranging restriction code.

After receiving the ranging announcement message, the second UE 32 can compare the first ranging restriction code in the ranging announcement message with the second ranging restriction code sent to the second UE 32 by the core network 40. If the first ranging restriction code corresponds to the second ranging restriction code, it is determined that the ranging announcement message is the ranging announcement message that the second UE 32 needs to monitor. The second UE 32 may determine the ranging integrity key and the ranging encryption key of the ranging announcement message to be monitored.

When determining that the received ranging announcement message is the ranging announcement message that the second UE 32 needs to monitor, the second UE 32 may send, to the core network 40, the long-term key identifier and the random number in the ranging announcement message to request the core network 40 to determine the intermediate key.

In one embodiment, the method also includes:
Verifying integrity of the ranging announcement message according to the ranging integrity key; and/or decrypting the predetermined encrypted information under encryption protection according to the ranging encryption key; and
determining whether the ranging announcement message is accepted based on a result of validating integrity and/or a result of deciphering.

The second UE 32 carries out integrity verification of the ranging announcement message by using the ranging integrity key, and decrypts the encrypted information of the ranging announcement message by using the ranging encryption key.

If the integrity verification is successful, it may be determined that the ranging announcement message is not tampered with, or the ranging announcement message is transmitted correctly. The second UE 32 can accept the ranging announcement message, and decrypt the encrypted information of the ranging announcement message by using the ranging encryption key to acquire the encrypted information, such as ranging requirements. Response is made to the ranging announcement message of the first UE 30, such as sending a ranging signal.

If integrity verification and/or decryption fails, it may be determined that the ranging announcement message is tampered with or that the ranging announcement message is transmitted incorrectly. The second UE 32 may discard the ranging announcement message.

For example, as shown in FIG. 9, the step that the second UE 32 requests to monitor the direct link, obtains a long-term key from the core network 40, carries out integrity verification of the ranging announcement message by using the ranging integrity key, and decrypts the encrypted information of the ranging announcement message by using the ranging encryption key includes the following steps.

Step 901: the second UE 32 sends, to the core network 40, a monitoring request (discovery request) that carries a ranging layer identifier of the second UE 32 at a ranging layer, and requests to monitor the direct link.

Step 902: the second UE 32 receives a discovery response in response to the monitoring request that is sent by the core network 40 (RKMF), the discovery response including a second ranging restriction code (there may be one or more second ranging restriction codes); and the RKMF authorizes, according to the service profile defined by the application layer, the second UE 32 to monitor the specific ranging announcement message.

Step 903: the second UE 32 performs monitoring on the direct link by monitoring the ranging announcement message.

Step 904: the second UE 32 is in the coverage of the mobile communication network. After receiving the ranging announcement message which is sent by the first UE 30 and matches the ranging restriction code of the second UE 32, the second UE 32 sends an intermediate key request to the core network 40 (RKMF). The intermediate key request includes: a long-term key identifier in the ranging announcement message and a random number for generating the intermediate key. The RKMF determines a long-term key according to the long-term key identifier. The intermediate key is generated using the long-term key and the random number, and the manner in which RKMF generates the intermediate key is the same as the manner in which the first UE 30 generates the intermediate key.

Step 905: the second UE 32 receives an intermediate key response, the intermediate key response including an intermediate key generated by the RKMF, where the manner in which the RKMF generates the intermediate key is the same as the manner in which the first UE 30 generates the intermediate key.

Step 906: the second UE 32 generates the ranging integrity key. The second UE 32 receives the intermediate key KD, first of all generates the session key KD-sess, and then generates the ranging integrity key (RIK) and the ranging encryption key (REK). The manner in which the second UE 32 uses the intermediate key to generate the ranging integrity key and the ranging encryption key is the same as the manner that the first UE 30 uses.

Step 907: the second UE 32 carries out integrity verification of the ranging announcement message, and uses the ranging encryption key to decrypt the encrypted information of the ranging announcement message. If integrity verification and/or decryption fails, the second UE 32 terminates the ranging announcement message of the first UE 30. Thereafter, if the time stamp and the random number in the ranging announcement message indicate that there is no replay attack, the second UE 32 discovers the correct first UE 30. Otherwise, the second UE 32 terminates the ranging announcement message of the first UE 30.

A specific example is provided below in combination with any of the above embodiments.

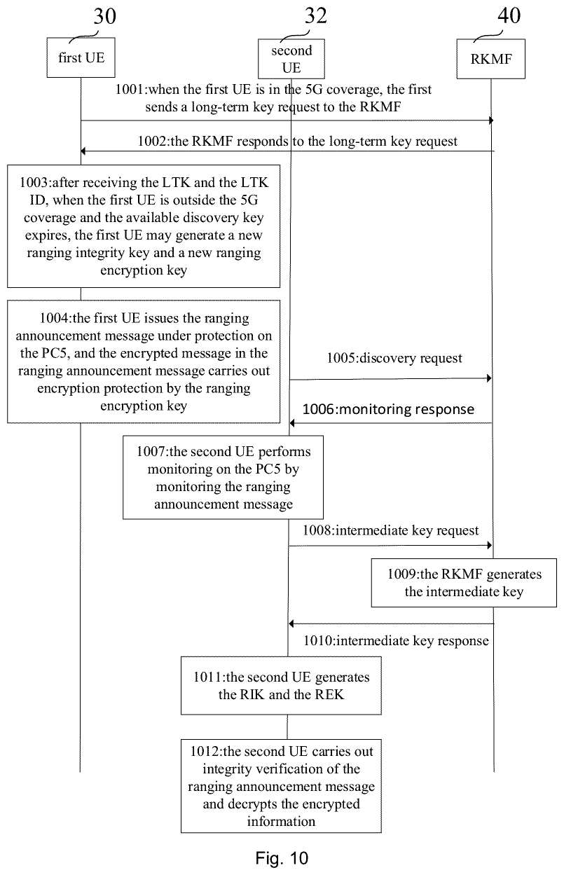

FIG. 10 shows the discovery process of safe ranging restrictions in some 5G coverage scenarios. The first UE 30, the second UE 32 and the core network 40 can set the security algorithm identifier in the same way. For example, a security algorithm identifier is set as described in 3GPP TS 33.501. It is assumed that the first UE 30 in the 5G coverage has been pre-configured by the network or provided with information of the target UE 2 that the first UE 30 can discover.

In order to protect traffic between the UE and the Ranging Key Management Function (RKMF), the UE and the RKMF support the security requirements and procedures in mobile communication network standards (such as 3GPP TS 33.503 Section 5.2.5).

Step 1001: it is assumed that a UE is uniquely identified by the ranging layer identifier (ID). When still in the 5G coverage, the first UE 30 may obtain a long-term key (LTK) from the RKMF. When in the coverage of the mobile communication network, the first UE 30 can send a long-term key request to the RKMF.

Step 1002: the RKMF responds to the long-term key request. After receiving the LTK request, the RKMF generates and sends the LTK and the Long-Term Key Identity (LTK ID) to the first UE 30. The LTK ID is used to uniquely identify the LTK, and the RKMF stores the LTK and LTK ID locally.

Step 1003: after receiving the LTK and the LTK ID, when the first UE 30 is outside the 5G coverage and the available discovery key expires, the first UE 30 may generate a new ranging integrity key and a new ranging encryption key. Specifically, the first UE 30 first generates an intermediate key (KD) according to the LTK by using the KDF specified in Annex B of TS 33.220. Thereafter, the first UE 30 derives the session key KD-sess based on the KD. Finally, the first UE 30 derives the ranging integrity key (RIK) and the ranging encryption key (REK) based on KD-sess, so as to protect integrity and encryption of the ranging announcement message.

Step 1004: the ranging announcement message includes a time stamp, a ranging code, a ranging requirement, etc. The first UE 30 first encrypts sensitive information, that is, the encrypted message (such as a ranging requirement) in the ranging announcement message by using the REK. Thereafter, the ranging announcement messages under encryption protection: encrypted sensitive information, the LTK ID of the first UE 30, the random number for generating the intermediate KD, and the identifier of the security algorithm for encryption protection and integrity protection, are all integrity-protected by the RIK. Finally, the first UE 30 issues the ranging announcement message under encryption protection and integrity protection on the PC5.

Step 1005: the second UE 32 sends a monitoring request (discovery request). The second UE 32 requests to monitor the PC5 by sending its ranging layer ID to the RKMF.

Step 1006: the RKMF sends a monitoring response. According to the monitoring request of the second UE 32, the RKMF authorizes the second UE 32 to monitor the specific target according to a service profile defined by the application layer. The RKMF sends information of a set of valid target ranging application codes to the second UE 32 in the monitoring response.

Step 1007: the second UE 32 performs monitoring on the PC5 by monitoring the ranging announcement message.

Step 1008: the second UE 32 in the 5G coverage. After receiving the ranging announcement message sent by the first UE 30, the second UE 32 sends an intermediate key KD request. Specifically, the second UE 32 sends, to the RKMF, the LTK ID of the first UE 30 in the ranging announcement message and the random number for generating KD.

Step 1009: after receiving the discovery key request message from the second UE 32, the RKMF checks whether the second UE 32 can monitor the first UE 30 according to the service profile. If the second UE 32 is not authorized to monitor the first UE 30, the RKMF terminates the discovery process. If the second UE 32 is authorized to monitor the first UE 30, the RKMF calculates the intermediate key KD according to the LTK of the first UE 30 and the random number.

Step 1010: the RKMF sends, to the second UE 32, an intermediate key KD response including a newly generated KD, the RKMF generates the newly generated KD in the same manner as the first UE 30 generates the KD.

Step 1011: the second UE 32 generates the RIK. The second UE 32 receives the newly generated KD, generates KD-sess first, and then generates the RIK and REK. The manner in which the second UE 32 generates the RIK and REK based on the newly generated KD is the same as the manner in which the first UE 30 generates the RIK and REK based on the KD and the random number.

Step 1012: the second UE 32 carries out integrity verification of the ranging announcement message and decrypts the encrypted information. If integrity verification or decryption fails, the second UE 32 terminates the ranging announcement message of the first UE 30. If the time stamp and the random number in the ranging announcement message indicate that there is no replay attack, the second UE 32 discovers the correct first UE 30. Otherwise, the second UE 32 terminates the ranging announcement message of the first UE 30.

An example of determining the key is given below.

When calculating the KD from the LTK, the following parameters are used to form an input S of the KDF specified in Annex B of 3GPP TS 33.220 [2]:
FC=0x58
P0=random number_1 (such as a ranging layer identifier)
L0=length of the random number_1 (such as 0x00 0x03)
P1=random number_2 (such as a ranging service code)
L1=length of the random number_2 (such as 0x00 0x10)
P2=random number_3 (optional)
L2=length of the random number_3 (such as 0x00 0x10)

The input LTK is 256 bits.

An example of calculating KD-sess from the KD is given below.

When calculating KD-sess from the KD, the following parameters are used to form an input S of the KDF specified in Annex B of 3GPP TS 33.220 [2]:
FC=0x5E
P0=random number 4
L0=length of the random number_4 (such as 0x00 0x10)
P1=random number_5 (such as a ranging service code)
L1=length of the random number_5 (such as 0x00 0x10)

The input KD is 256 bits.

An example of calculating the RIK is given below. When calculating the RIK from KD-sess, the following parameters are used to form an input S of the KDF specified in Annex B of 3GPP TS 33.220 [2]:
FC=0x5B
P0=0x01 (ranging integrity key) or 0x01 (ranging encryption key)-L0=length of P0 (such as 0x00 0x10)
P1=algorithm identifier
L1=length of the algorithm identifier (such as 0x00 0x10) The algorithm identifier is set as described in 3GPP TS 33.501 [3].

The input KD-sess is 256 bits.

For an algorithm key with a length of n bits, where n is less than or equal to 256, the n least significant bits of the 256 bits output by the KDF are used as the algorithm key.

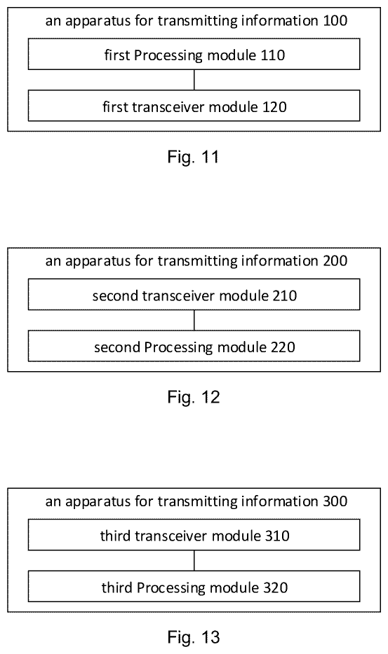

An Embodiment of the present disclosure also provides an apparatus for transmitting information, as shown in FIG. 11, which is performed by a first UE of cellular mobile wireless communication, where the apparatus 100 includes:
a first processing module 110, configured to determine a ranging integrity key and a ranging encryption key of a ranging announcement message according to long-term key information sent by a core network, where the ranging integrity key and the ranging encryption key are used to carry out, in response to determining that the first UE is unable to acquire a discovery key from a mobile communication network, integrity protection of the ranging announcement message and encryption protection of predetermined encrypted information in the ranging announcement message in place of the discovery key, respectively.

In one embodiment, the first processing module 110 is specifically configured to:
determine an intermediate key according to a long-term key and a random number; and
determine the ranging integrity key and the ranging encryption key according to the intermediate key.

In one embodiment, the apparatus also includes:
a first transceiver module 120, configured to send a ranging announcement message that uses the ranging integrity key to carry out integrity protection on a direct link, wherein the ranging announcement message comprises at least one of: indicated predetermined encrypted information that uses the ranging encryption key to carry out encryption protection; and
a long-term key identifier of the long-term key and the random number, where the long-term key identifier is determined according to the long-term key information.

In one embodiment, the first transceiver module 120 is specifically configured to:
in response to determining that the first UE fails to connect to the mobile communication network, send the ranging announcement message that uses the ranging integrity key to carry out integrity protection.

In one embodiment, the ranging announcement message also includes at least one of:
a time stamp that the first UE sends the ranging announcement message;
an identifier of a ranging integrity algorithm that uses the ranging integrity key to carry out integrity protection;
an identifier of a ranging encryption algorithm that uses the ranging encryption key to carry out encryption protection; and
ranging requirements.

In one embodiment, the ranging announcement message also includes a first ranging restriction code, where the first ranging restriction code is used to identify the ranging announcement message.

In one embodiment, the first UE being unable to obtain a discovery key from a mobile communication network includes:
disconnect the first UE with the mobile communication network in response to determining that the discovery key is invalidated obtained from the mobile communication network.

In one embodiment, the long-term key information includes a long-term key and/or a long-term key identifier of a long-term key.

An embodiment of the present disclosure also provides an apparatus for transmitting information, as shown in FIG. 12, which is performed by a core network of cellular mobile wireless communication, where the apparatus 200 includes:
a second transceiver module 210, configured to send long-term key information to a first UE;
where the long-term key information is used for determining a ranging integrity key and a ranging encryption key of a ranging announcement message by the first UE, wherein the ranging integrity key and the ranging encryption key are used to carry out, in response to determining that the first UE is unable to acquire a discovery key from a mobile communication network, integrity protection of the ranging announcement message and encryption protection of predetermined encrypted information in the ranging announcement message in place of the discovery key, respectively.

In one embodiment, the second transceiver module 210 is also configured to receive a long-term key identifier and a random number sent by a second UE through the mobile communication network.

The apparatus also includes a second processing module 220, configured to:
determine an intermediate key based on a long-term key corresponding to the long-term key identifier and the random number; and
send the intermediate key to the second UE through the mobile communication network.

In one embodiment, the second transceiver module 210 is specifically configured to:
send the long-term key information to the first UE through the mobile communication network in response to determining that the first UE has a ranging layer identifier corresponding to the first UE at a ranging layer.

In one embodiment, the second transceiver module 210 is also configured to:
receive a monitoring request which is sent by the second UE through the mobile communication network and carries at least a ranging layer identifier of the second UE; and
in response to determining that the second UE is allowed to monitor the ranging announcement message based on an application layer rule, send a second ranging restriction code to the second UE through the mobile communication network, where the second ranging restriction code is used to indicate the ranging announcement message that the second UE needs to monitor.

In one embodiment, the first UE being unable to obtain a discovery key from a mobile communication network includes: the first UE being disconnected from the mobile communication network when the discovery key obtained from the mobile communication network is invalidated.

In one embodiment, the long-term key information includes a long-term key and/or a long-term key identifier of a long-term key.

An embodiment of the present disclosure also provides an apparatus for transmitting information, as shown in FIG. 13, which is performed by a second UE of cellular mobile wireless communication, where the apparatus 300 includes:
a third transceiver module 310, which is configured to receive a ranging announcement message sent by a first UE on a direct link, where the ranging announcement message includes a long-term key identifier of a long-term key, where the long-term key identifier is used for determining a ranging integrity key and a ranging encryption key of the ranging announcement message by the second UE, wherein the ranging integrity key and the ranging encryption key are used to carry out, in response to determining that the first UE is unable to acquire a discovery key from a mobile communication network, integrity protection of the ranging announcement message and encryption protection of predetermined encrypted information in the ranging announcement message in place of the discovery key, respectively.

In one embodiment, the ranging announcement message also includes a random number, and
the third transceiver module 310 is also configured to:
send the long-term key identifier and the random number to a core network; and
receive an intermediate key sent by the core network through the mobile communication network in response to the long-term key identifier and the random number; and
the apparatus also includes a third processing module 320, configured to:
determine the ranging integrity key and the ranging encryption key according to the intermediate key.

In one embodiment, the third processing module 320 is also configured to:
carry out integrity verification of the ranging announcement message according to the ranging integrity key; and/or decrypt the predetermined encrypted information under encryption protection according to the ranging encryption key; and
determine whether the ranging announcement message is accepted according to a result of validating integrity and/or a result of deciphering.

In one embodiment, the third transceiver module 310 is also configured to:
send, to the core network, a monitoring request that carries at least a ranging layer identifier of the second UE at a ranging layer; and
receive a second ranging restriction code sent by the core network in response to the monitoring request, where the second ranging restriction code is used to indicate the ranging announcement message that the second UE needs to monitor.

In one embodiment, the third transceiver module 310 is specifically configured to:
send the long-term key identifier and the random number to the core network in response to determining that a first ranging restriction code in the ranging announcement message has a corresponding relationship with the second ranging restriction code.

In one embodiment, the ranging announcement message also includes at least one of:
a time stamp that the first UE sends the ranging announcement message;
an identifier of a ranging integrity algorithm that uses the ranging integrity key to carry out integrity protection;
an identifier of a ranging encryption algorithm that uses the ranging encryption key to carry out encryption protection; and
ranging requirements.

In one embodiment, the third processing module 320 is also configured to:
determine whether the ranging announcement message is replayed according to the time stamp and/or the random number.

In one embodiment, the first UE being unable to obtain a discovery key from a mobile communication network includes: the first UE being disconnected from the mobile communication network when the discovery key obtained from the mobile communication network is invalidated.

In an illustrative example, the first processing module 110, the first transceiver module 120, the second transceiver module 210, the second processing module 220, the third transceiver module 310, the third processing module 320, etc., may be implemented by one or more Central Processing Units (CPUs), Graphics Processing Units (GPUs), Baseband Processors (BPs), Application Specific Integrated Circuits (ASICs), DSPs, Programmable Logic Devices (PLDs), Complex Programmable Logic Devices (CPLDs), Field Programmable Gate Arrays (FPGAs), general purpose processors, controllers, Micro Controller Units (MCUs), microprocessors, or other electronic components to execute the foregoing methods.

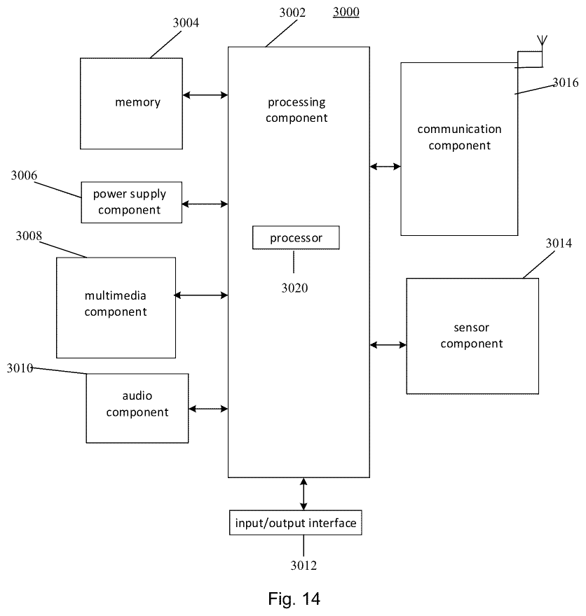

FIG. 14 is a block diagram of an information transmission apparatus 3000 according to an illustrative example. For example, the apparatus 3000 may be a mobile phone, a computer, a digital broadcast terminal, a messaging device, a game console, a tablet device, a medical device, a fitness device, a personal digital assistant, etc.

Referring to FIG. 14, the apparatus 3000 may include one or more of the following components: a processing component 3002, a memory 3004, a power supply component 3006, a multimedia component 3008, an audio component 3010, an input/output (I/O) interface 3012, a sensor component 3014, and a communication component 3016.

The processing component 3002 generally controls the overall operation of the apparatus 3000, such as operations associated with display, telephone call, data communication, camera operation and recording operation. The processing component 3002 may include one or more processors 3020 to execute instructions, so as to complete all or some of the steps of the method described above. Further, the processing component 3002 may include one or more modules to facilitate the interaction between the processing component 3002 and other components. For example, the processing component 3002 may include a multimedia module to facilitate the interaction between the multimedia component 3008 and the processing component 3002.

The memory 3004 is configured to store various types of data to support operations on the apparatus 3000. Examples of such data include instructions for any application or method operating on the apparatus 3000, contact data, phone book data, messages, pictures, videos, etc. The memory 3004 may be achieved by any type of volatile or nonvolatile storage devices or their combination, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk or an optical disk.

The power supply component 3006 provides power to various components of the apparatus 3000. The power supply component 3006 may include a power management system, one or more power supplies, and other components associated with generating, managing and distributing power for the apparatus 3000.

The multimedia component 3008 includes a screen that provides an output interface between the apparatus 3000 and the user. In some embodiments, the screen may include a Liquid Crystal Display (LCD) and a Touch Panel (TP). If the screen includes a touch panel, the screen may be implemented as a touch screen to receive an input signal from the user. The touch panel includes one or more touch sensors to sense touch, sliding and gestures on the touch panel. The touch sensor may not only sense the boundary of a touch or sliding action, but also detect the duration and pressure related to the touch or sliding operation. In some embodiments, the multimedia component 3008 includes a front camera and/or a rear camera. When the apparatus 3000 is in an operation mode, such as a shooting mode or a video mode, the front camera and/or the rear camera may receive external multimedia data. Each of the front camera and the rear camera may be a fixed optical lens system or have a focal length and an optical zoom capability.

The audio component 3010 is configured to output and/or input an audio signal. For example, the audio component 3010 includes a microphone (MIC), which is configured to receive an external audio signal when the apparatus 3000 is in an operation mode, such as a call mode, a recording mode, and a voice recognition mode. The received audio signal may be further stored in the memory 3004 or sent via the communication component 3016. In some embodiments, the audio component 3010 also includes a speaker for outputting an audio signal.

The I/O interface 3012 provides an interface between the processing component 3002 and a peripheral interface module. The above peripheral interface module may be a keyboard, a click wheel, a button, etc. These buttons may include, but are not limited to, a home button, a volume button, a start button, and a lock button.

The sensor component 3014 includes one or more sensors, which are configured to provide the state evaluation of various aspects to the apparatus 3000. For example, the sensor component 3014 may detect the on/off state of the apparatus 3000 and the relative positioning of components such as a display and a keypad of the apparatus 3000. The sensor component 3014 may also detect the position change of the apparatus 3000 or a component of the apparatus 3000, the presence or absence of user contact with the apparatus 3000, the orientation or acceleration/deceleration of the apparatus 3000, and the temperature change of the apparatus 3000. The sensor component 3014 may include a proximity sensor, which is configured to detect the presence of a nearby object without any physical contact. The sensor component 3014 may also include an optical sensor, such as a CMOS or CCD image sensor, for use in an imaging application. In some embodiments, the sensor component 3014 may also include an acceleration sensor, a gyro sensor, a magnetic sensor, a pressure sensor or a temperature sensor.

The communication component 3016 is configured to facilitate wired or wireless communication between the apparatus 3000 and other devices. The apparatus 3000 may access a wireless network based on communication standards, such as WiFi, 2G or 3G or their combination. In an illustrative example, the communication component 3016 receives a broadcast signal or broadcast-related information from an external broadcast management system via a broadcast channel. In an illustrative example, the communication component 3016 also includes a Near Field Communication (NFC) module to facilitate short-range communication. For example, the NFC module may be implemented based on a Radio Frequency Identification (RFID) technology, an Infrared Data Association (IrDA) technology, an Ultra-Wideband (UWB) technology, a Bluetooth (BT) technology and other technologies.

In an illustrative example, the apparatus 3000 may be implemented by one or more of an Application Specific Integrated Circuit (ASIC), a Digital Signal Processor (DSP), a Digital Signal Processing Device (DSPD), a Programmable Logic Device (PLD), a Field Programmable Gate Array (FPGA), a controller, a microcontroller, a microprocessor, or other electronic components for performing the methods described above.

In an illustrative example, a non-transitory computer-readable storage medium including instructions is also provided, such as the memory 3004 including instructions. The above instructions may be executed by the processor 3020 of the apparatus 3000 to complete the methods described above. For example, the non-transitory computer-readable storage medium may be a ROM, a Random Access Memory (RAM), a CD-ROM, a magnetic tape, a floppy disk, an optical data storage device, etc.

Those skilled in the art would readily conceive other implementations of the embodiments of the present disclosure upon consideration of the specification and practice of the present disclosure here. The present disclosure is intended to cover any variations, uses, or adaptive changes of the embodiments of the present disclosure. These variations, uses, or adaptive changes follow the general principles of the embodiments of the present disclosure and include common general knowledge or customary technical means in the technical field that are not disclosed in the embodiments of the present disclosure. The specification and embodiments are to be regarded as illustrative merely, and the true scope and spirit of the embodiments of the present disclosure is indicated by the following claims.

It is to be understood that the embodiments of the present disclosure are not limited to the precise structure that has been described above and illustrated in the accompanying drawings, and that various modifications and changes can be made without departing from the scope of the present disclosure. The scope of the embodiments of the present disclosure is limited merely by the appended claims.

1. A method for transmitting information, performed by a first user equipment (UE), and comprising:
determining a ranging integrity key and a ranging encryption key of a ranging announcement message according to long-term key information sent by a core network, wherein the ranging integrity key and the ranging encryption key are used to carry out, in response to determining that the first UE is unable to acquire a discovery key from a mobile communication network, integrity protection of the ranging announcement message and encryption protection of predetermined encrypted information in the ranging announcement message in place of the discovery key, respectively.

2. The method according to claim 1, wherein determining the ranging integrity key and the ranging encryption key of the ranging announcement message according to long-term key information sent by the core network comprises:
determining an intermediate key based on a long-term key and a random number; and
determining the ranging integrity key and the ranging encryption key according to the intermediate key.

3. The method according to claim 2, further comprising:
Sending, on a direct link a ranging announcement message that uses the ranging integrity key to carry out integrity protection, wherein the ranging announcement message comprises at least one of:
indicated predetermined encrypted information that uses the ranging encryption key to carry out encryption protection; or
a long-term key identifier of the long-term key and the random number, wherein the long-term key identifier is determined based on the long-term key information.

4. The method according to claim 3, wherein sending the ranging announcement message that uses the ranging integrity key to carry out integrity protection on the direct link comprises:
sending the ranging announcement message that uses the ranging integrity key to carry out integrity protection, in response to determining that the first UE fails to connect to the mobile communication network.

5. (canceled)

6. The method according to claim 1, wherein the ranging announcement message further comprises a first ranging restriction code, wherein the first ranging restriction code is used to identify the ranging announcement message.

7. The method according to claim 1, wherein the first UE being unable to obtain the discovery key from the mobile communication network comprises:
determining that the discovery key obtained from the mobile communication network is invalidated, disconnecting the first UE from the mobile communication network.

8. The method according to claim 1, wherein the long-term key information comprises a long-term key and/or a long-term key identifier of the long-term key.

9. A method for transmitting information, performed by a core network, comprising:
sending long-term key information to a first UE;
wherein the long-term key information is used for determining a ranging integrity key and a ranging encryption key of a ranging announcement message by the first UE, wherein the ranging integrity key and the ranging encryption key are used to carry out, in response to determining that the first UE is unable to acquire a discovery key from a mobile communication network, integrity protection of the ranging announcement message and encryption protection of predetermined encrypted information in the ranging announcement message in place of the discovery key, respectively.

10. The method according to claim 9, further comprising:
receiving a long-term key identifier and a random number sent by a second UE through the mobile communication network;
determining an intermediate key according to a long-term key corresponding to the long-term key identifier and the random number; and
sending the intermediate key to the second UE through the mobile communication network.

11. The method according to claim 9, wherein sending the long-term key information to the first UE comprises:
sending the long-term key information to the first UE through the mobile communication network in response to determining that the first UE has a ranging layer identifier corresponding to the first UE at a ranging layer.

12. The method according to claim 9, further comprising:
receiving a monitoring request carries at least a ranging layer identifier of the second UE, which is sent by the second UE through the mobile communication network; and
sending a second ranging restriction code to the second UE through the mobile communication network, in response to determining that the second UE is allowed to monitor the ranging announcement message according to an application layer rule, wherein the second ranging restriction code is used for indicating the ranging announcement message that the second UE needs to monitor.

13.-14. (canceled)

15. A method for transmitting information, performed by a second UE, comprising:
receiving a ranging announcement message sent by a first UE on a direct link, wherein the ranging announcement message comprises a long-term key identifier of a long-term key, wherein the long-term key identifier is used for determining a ranging integrity key and a ranging encryption key of the ranging announcement message by the second UE, wherein the ranging integrity key and the ranging encryption key are used to carry out, in response to determining that the first UE is unable to acquire a discovery key from a mobile communication network, integrity protection of the ranging announcement message and encryption protection of predetermined encrypted information in the ranging announcement message in place of the discovery key, respectively.

16. The method according to claim 15, wherein:
the ranging announcement message further comprises a random number, and the method further comprises:
sending the long-term key identifier and the random number to a core network;
receiving an intermediate key sent by the core network through the mobile communication network in response to the long-term key identifier and the random number; and
determining the ranging integrity key and the ranging encryption key according to the intermediate key.

17. The method according to claim 16, further comprising:
verifying integrity of the ranging announcement message according to the ranging integrity key; and/or decrypting the predetermined encrypted information under encryption protection according to the ranging encryption key; and
determining, whether the ranging announcement message is accepted according to a result of validating integrity and/or a result of deciphering.

18. The method according to claim 16, further comprising:
sending a monitoring request that carries at least a ranging layer identifier of the second UE at a ranging layer to the core network; and
receiving a second ranging restriction code sent by the core network in response to the monitoring request, wherein the second ranging restriction code is used for indicating the ranging announcement message that the second UE needs to monitor.

19. The method according to claim 18, wherein receiving the intermediate key sent by the core network through the mobile communication network in response to the long-term key identifier and the random number comprises:
sending the long-term key identifier and the random number to the core network in response to determining that a first ranging restriction code in the ranging announcement message has a corresponding relationship with the second ranging restriction code.

20. The method according to claim 16, wherein the ranging announcement message further comprises at least one of:
a time stamp that the first UE sends the ranging announcement message;
an identifier of a ranging integrity algorithm that uses the ranging integrity key to carry out integrity protection;
an identifier of a ranging encryption algorithm that uses the ranging encryption key to carry out encryption protection; or
ranging requirements.

21. The method according to claim 20, further comprising:
determining whether the ranging announcement message is replayed according to the time stamp and/or the random number.

22.-25. (canceled)

26. A communication device, comprising a processor, a memory, and an executable program stored in the memory and runnable by the processor, wherein the executable program when executed by the processor, implements the steps of the method for transmitting information according to claim 1.

27. A storage medium, storing an executable program which, when executed by a processor, implements the steps of the method for transmitting information according to claim 1.
